(19) United States
(12) Patent Application Publication
(10) Pub. No.: US 2026/0238798 A1
(43) Pub. Date: Aug. 13, 2026

(54) AN APPARATUS, A METHOD AND A COMPUTER PROGRAM FOR VIDEO CODING AND DECODING

(71) Applicant: Nokia Technologies Oy, Espoo (FI)

(72) Inventors: Nannan ZOU, Tampere (FI); Francesco CRICRÌ, Tampere (FI); Honglei ZHANG, Tampere (FI)

(21) Appl. No.: 19/474,824

(22) PCT Filed: Mar. 28, 2024
(86) PCT No.: PCT/EP2024/058415

§ 371 Date: Oct. 13, 2025

Related U.S. Application Data
(60) Provisional application No. 63/498,121, filed on Apr. 25, 2023.

(51) Int. Cl. H04N 19/147; H04N 19/124; H04N 19/13; H04N 19/172; H04N 19/42; H04N 19/593; H04N 19/70

(52) U.S. Cl. CPC H04N 19/147; H04N 19/124; H04N 19/13; H04N 19/172; H04N 19/42; H04N 19/593; H04N 19/70

(57) ABSTRACT

A method comprising: receiving input data comprising an initial reconstruction of an input data of an encoder, an encoded residual, wherein the encoded residual is determined based at least on a ground truth data of the encoder and the initial reconstruction of the input data and an adaptation signal into a decoder, said decoder comprising at least a first sub-decoder, a syntax generation unit and a probability model; obtaining an entropy decoded residual component based at least on the encoded residual component and on one or more probabilities of the probability model, wherein the entropy decoded residual is represented as a plurality of decoded latent tensor elements; providing the entropy decoded residual component to the first sub-decoder; providing the adaptation signal to the syntax generation unit for generating one or more syntaxes based on the adaptation signal; adapting decoding of the residual component in the first sub-decoder based on said one or more syntaxes; obtaining a reconstructed residual component from an output of the first sub-decoder; and combining the reconstructed residual component with initial reconstruction of the input data to obtain a final reconstruction of the input data.

### TECHNICAL FIELD

The present invention relates to an apparatus, a method and a computer program for video coding and decoding.

### BACKGROUND

In video coding, video and image samples are typically encoded using color representations such as YUV or YCbCr consisting of one luminance (luma) channel, denoted also as Y, and two chrominance (chroma) channels, denoted also as U, V or as Cb, Cr. In these cases the luminance channel, representing mostly the illumination of the scene, is typically coded at certain resolution, while the chrominance channels, representing typically differences between certain color components, are often coded at a second resolution lower than that of the luminance signal. The intention of this kind of a differential representation is to decorrelate the color components and be able to compress the data more efficiently.

Neural networks (NNs) have been used in the context of image and video compression by replacing one or more of the components of a traditional codec, or by utilizing an end-to-end learned compression.

However, the NN-based video coding approaches, including the solutions based on the end-to-end learned compression, have shown to be inadequate in terms of optimizing the rate-distortion performance of the codecs.

### SUMMARY

In order to at least alleviate the above problems, enhanced methods for improving the rate-distortion performance are introduced herein.

The scope of protection sought for various embodiments of the invention is set out by the independent claims. The embodiments and features, if any, described in this specification that do not fall under the scope of the independent claims are to be interpreted as examples useful for understanding various embodiments of the invention.

A method according to a first aspect comprises receiving input data comprising a first ground truth data; providing the first ground truth data into a first encoder, said ground truth data comprising at least a first part of the input data; obtaining an initial encoded input data from an output of the first encoder; providing the initial encoded input data into a first decoder; obtaining an initial reconstruction of the input data from an output of the first decoder; determining a residual based at least on the first ground truth data and the initial reconstruction of the input data; providing a second ground truth data comprising at least the residual into a second encoder, said second encoder comprising at least a first sub-encoder and a probability model; providing the second ground truth data into the first sub-encoder; providing an output of the first sub-encoder to the probability model; obtaining one or more first probabilities from an output of the probability model; and obtaining, based on the output of the first sub-encoder and on the one or more probabilities, an encoded residual information from an output of the second encoder.

A method according to a second aspect comprises receiving input data comprising an initial reconstruction of an input data of an encoder, an encoded residual, wherein the encoded residual is determined based at least on a ground truth data of the encoder and the initial reconstruction of the input data and an adaptation signal into a decoder, said decoder comprising at least a first sub-decoder, a syntax generation unit and a probability model; obtaining an entropy decoded residual based at least on the encoded residual component and on one or more probabilities of the probability model, wherein the entropy decoded residual is represented as a plurality of decoded latent tensor elements; providing the entropy decoded residual to the first sub-decoder; providing the adaptation signal to the syntax generation unit for generating one or more syntaxes based on the adaptation signal; adapting decoding of the residual in the first sub-decoder based on said one or more syntaxes; obtaining a reconstructed residual from an output of the first sub-decoder; and combining the reconstructed residual with initial reconstruction of the input data to obtain a final reconstruction of the input data.

An apparatus according to a third aspect comprises means for receiving input data comprising a first ground truth data; means for providing the first ground truth data into a first encoder, said ground truth data comprising at least a first part of the input data; means for obtaining an initial encoded input data from an output of the first encoder; means for providing the initial encoded input data into a first decoder; means for obtaining an initial reconstruction of the input data from an output of the first decoder; means for determining a residual based at least on the first ground truth data and the initial reconstruction of the input data; means for providing a second ground truth data comprising at least the residual into a second encoder, said second encoder comprising at least a first sub-encoder for the second ground truth data and a probability model; means for providing the second ground truth data into the first sub-encoder; means for providing an output of the first sub-encoder to the probability model; means for obtaining one or more first probabilities from an output of the probability model; and means for obtaining, based on the output of the first sub-encoder and on the one or more probabilities, an encoded residual information from an output of the second encoder.

According to an embodiment, the first encoder, the first decoder and the second encoder belong to an end-to-end learned intra-frame codec.

According to an embodiment, said first encoder comprises a neural encoder, a probability model and an entropy encoder; the neural encoder comprising means for converting the input data into a plurality of latent tensor elements; the probability model comprising means for estimating a probability of one or more of the plurality of latent tensor elements; and the entropy encoder comprising means for outputting a bitstream encoded at least partly based on the plurality of latent tensor elements and the probability of one or more of the plurality of latent tensor elements.

An apparatus according to a fourth aspect comprises means for receiving input data comprising an initial reconstruction of an input data of an encoder, an encoded residual, wherein the encoded residual is determined based at least on a ground truth data of the encoder and the initial reconstruction of the input data and an adaptation signal into a decoder, said decoder comprising at least a first sub-decoder, a syntax generation unit and a probability model; means for obtaining an entropy decoded residual based at least on the encoded residual and on one or more probabilities of the probability model, wherein the entropy decoded residual is represented as a plurality of decoded latent tensor elements; means for providing the entropy decoded residual to the first sub-decoder; means for providing the adaptation signal to the syntax generation unit for generating one or more syntaxes based on the adaptation signal; means for adapting decoding of the residual in the first sub-decoder based on said one or more syntaxes; means for obtaining a reconstructed residual from an output of the first sub-decoder; and means for combining the reconstructed residual with initial reconstruction of the input data to obtain a final reconstruction of the input data.

According to an embodiment, said decoder comprises an entropy decoder and a neural decoder; wherein the probability model of the decoder comprising means for estimating a probability of one or more elements in the plurality of decoded latent tensor element; the entropy decoder comprising means for outputting a plurality of decoded latent tensor elements at least partly based on the input data and the probability of one or more elements in the plurality of latent tensor element; and the neural decoder comprising means for converting the plurality of decoded latent tensor elements into the reconstructed chroma component.

According to an embodiment, said first sub-decoder of the decoder is a neural decoder comprising one or more spatial attention units for receiving said one or more syntaxes and adapting the decoding of the residual component.

According to an embodiment, the adaptation signal input to the syntax generation network is a dequantized latent tensor output by another codec.

According to an embodiment, the adaptation signal input to the syntax generation network is the initial reconstruction of input data.

According to an embodiment, the adaptation signal input to the syntax generation network is an output of an auxiliary encoder.

According to an embodiment, the decoder belongs to an end-to-end learned intra-frame codec.

As a fifth aspect, there is provided an apparatus comprising: at least one processor and at least one memory, said at least one memory stored with code thereon, which when executed by said at least one processor, causes the apparatus to perform at least: receive input data comprising a first ground truth data; provide the first ground truth data into a first encoder, said ground truth data comprising at least a first part of the input data; obtain an initial encoded input data from an output of the first encoder; provide the initial encoded input data into a first decoder; obtain an initial reconstruction of the input data from an output of the first decoder; determine a residual based at least on the first ground truth data and the initial reconstruction of the input data; provide a second ground truth data comprising at least the residual into a second encoder, said second encoder comprising at least a first sub-encoder for the second ground truth data and a probability model; provide the second ground truth data into the first sub-encoder; provide an output of the first sub-encoder to the probability model; obtain one or more first probabilities from an output of the probability model; and obtain, based on the output of the first sub-encoder and on the one or more probabilities, an encoded residual information from an output of the second encoder.

An apparatus according to a sixth aspect comprises at least one processor and at least one memory, said at least one memory stored with code thereon, which when executed by said at least one processor, causes the apparatus to perform at least: receiving input data comprising an initial reconstruction of an input data of an encoder, an encoded residual, wherein the encoded residual is determined based at least on a ground truth data of the encoder and the initial reconstruction of the input data and an adaptation signal into a decoder, said decoder comprising at least a first sub-decoder, a syntax generation unit and a probability model; obtain an entropy decoded residual based at least on the encoded residual and on one or more probabilities of the probability model, wherein the entropy decoded residual is represented as a plurality of decoded latent tensor elements; provide the entropy decoded residual to the first sub-decoder; provide the adaptation signal to the syntax generation unit for generating one or more syntaxes based on the adaptation signal; adapt decoding of the residual in the first sub-decoder based on said one or more syntaxes; obtain a reconstructed residual from an output of the first sub-decoder; and combine the reconstructed residual with initial reconstruction of the input data to obtain a final reconstruction of the input data.

The computer readable storage media stored with code thereon are arranged to carry out the above methods and one or more of the embodiments related thereto.

### BRIEF DESCRIPTION OF THE DRAWINGS

For better understanding of the present invention, reference will now be made by way of example to the accompanying drawings in which:

FIG. 1 shows an example of a codec with neural network (NN) components;

FIG. 2 shows another example of a video coding system with neural network components;

FIG. 3 shows an example of a neural network-based end-to-end learned codec;

FIG. 4 shows an example of a neural network-based end-to-end learned video coding system;

FIG. 5 shows an example of a video coding for machines;

FIG. 6 shows an example of a pipeline for end-to-end learned system for video coding for machines;

FIG. 7 shows an example of training an end-to-end learned codec;

FIG. 8 shows an example of a Dense Split Attention (DSA) block;

FIGS. 9a and 9b show a flow chart of an encoding method and a decoding method for improving the rate-distortion performance according to an embodiment of the invention;

FIG. 10 illustrates an example implementation of a first-step codec according to an embodiment of the invention;

FIG. 11 illustrates an example implementation of a second-step codec according to an embodiment of the invention;

FIG. 12 illustrates an example implementation of a spatial attention block according to an embodiment of the invention;

FIG. 13 illustrates an example implementation of a first codec and second codec, wherein an output of the first codec is input to a decoder of the second codec;

FIG. 14 illustrates an example implementation of a first codec and second codec, wherein an output of the first codec is input to an encoder of the second codec;

FIG. 15 illustrates an example implementation of a first codec and second codec, wherein an output of the first codec is input to a probability model of the second codec;

FIG. 16 illustrates an example implementation of a first codec and second codec, wherein an output of the first codec is input to a decoder of the second codec, to an encoder of the second codec, and to a probability model of the second codec; and

FIG. 17 illustrates an example implementation of a first codec and second codec, wherein an output of the second codec is a final output representing a reconstruction of the input to the first codec.

### DETAILED DESCRIPTION OF SOME EXAMPLE EMBODIMENTS

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment is included in at least one embodiment of the disclosure.

Before discussing the present embodiments in more detailed manner, a short reference to related technology is given.

In the context of machine learning, a neural network (NN) is a computation graph consisting of several layers of computation, i.e., several portions of computation. Each layer consists of one or more units, where each unit performs an elementary computation. A unit is connected to one or more other units, and the connection may be associated with a weight. The weight may be used for scaling the signal passing through the associated connection. Weights are learnable parameters, i.e., values which can be learned from training data. There may be other learnable parameters, such as those of batch-normalization layers.

Two widely used architectures for neural networks are feed-forward and recurrent architectures. Feed-forward neural networks are such that there is no feedback loop: each layer takes input from one or more of the layers before and provides its output as the input for one or more of the subsequent layers. Also, units inside a certain layer take input from units in one or more of preceding layers and provide output to one or more of following layers.

Initial layers (those close to the input data) may extract semantically low-level features such as edges and textures in images, and intermediate and final layers may extract higher-level features. After the feature extraction layers there may be one or more layers performing a certain task, such as classification, semantic segmentation, object detection, denoising, style transfer, super-resolution, etc. In recurrent neural nets, there is a feedback loop, so that the network becomes stateful, i.e., it is able to memorize information or a state.

Neural networks are being utilized in an ever-increasing number of applications for many different types of devices, such as mobile phones. Examples include image and video analysis and processing, social media data analysis, device usage data analysis, etc.

A characteristic of at least some neural networks (and other machine learning tools) is that they are able to learn properties about input data, either in supervised way or in unsupervised way or both. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss. Examples of losses are mean squared error, cross-entropy, etc. In recent deep learning techniques, training is an iterative process, where at each iteration the algorithm modifies the weights of the neural net to make a gradual improvement of the network's output, i.e., to gradually decrease the loss.

In this description, terms “model” and “neural network” are used interchangeably, and also the weights of neural networks are sometimes referred to as learnable parameters or simply as parameters.

Training a neural network is an optimization process. The goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization. In practice, data may be split into at least two sets, the training set and the validation set. The training set is used for training the network, i.e., to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following things:
If the network is learning at all—in this case, the training set error should decrease, otherwise the model is in the regime of underfitting.
If the network is learning to generalize—in this case, also the validation set error needs to decrease and to be not too much higher than the training set error. If the training set error is low, but the validation set error is much higher than the training set error, or it does not decrease, or it even increases, the model is in the regime of overfitting. This means that the model has just memorized the training set's properties and performs well only on that set but performs poorly on a set not used for tuning its parameters.

While the above background information on neural networks may be valid at the time when this document was written, the field of neural networks and machine learning in general is developing at a fast pace. Thus, it is to be understood that at least some of the embodiments described herein are not limited to the definition of a neural network, or a machine learning model, or a training algorithm that was given in the background information above.

Lately, neural networks have been used for compressing and de-compressing data such as images, i.e., in an image codec. The most widely used architecture for realizing one component of an image codec is the auto-encoder, which is a neural network consisting of two parts: a neural encoder and a neural decoder. The neural encoder takes as input an image and produces a latent tensor which may require less bits than the input image. The latent tensor may be quantized and lossless compressed, to obtain a bitstream that represents the encoded image. The neural decoder takes in the bitstream and reconstructs the image which was input to the neural encoder.

Such neural encoder and neural decoder may be trained to minimize a combination of bitrate and distortion, where the distortion may be based on one or more of the following metrics: Mean Squared Error (MSE), Peak Signal-to-Noise Ratio (PSNR), Structural Similarity Index Measure (SSIM), or similar. These distortion metrics are meant to be correlated to the human visual perception quality, so that minimizing or maximizing one or more of these distortion metrics results into improving the visual quality of the decoded image as perceived by humans.

Video codec comprises an encoder that transforms the input video into a compressed representation suited for storage/transmission and a decoder that can decompress the compressed video representation back into a viewable form. An encoder may discard some information in the original video sequence in order to represent the video in a more compact form (that is, at lower bitrate).

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). Extensions of the H.264/AVC include Scalable Video Coding (SVC) and Multiview Video Coding (MVC).

The High Efficiency Video Coding (H.265/HEVC a.k.a. HEVC) standard was developed by the Joint Collaborative Team-Video Coding (JCT-VC) of VCEG and MPEG. The standard was published by both parent standardization organizations, and it is referred to as ITU-T Recommendation H.265 and ISO/IEC International Standard 23008-2, also known as MPEG-H Part 2 High Efficiency Video Coding (HEVC). Later versions of H.265/HEVC included scalable, multiview, fidelity range, three-dimensional, and screen content coding extensions which may be abbreviated SHVC, MV-HEVC, REXT, 3D-HEVC, and SCC, respectively.

Versatile Video Coding (H.266 a.k.a. VVC), defined in ITU-T Recommendation H.266 and equivalently in ISO/IEC 23090-3, (also referred to as MPEG-I Part 3) is a video compression standard developed as the successor to HEVC. A reference software for VVC is the VVC Test Model (VTM).

A specification of the AV1 bitstream format and decoding process were developed by the Alliance of Open Media (AOM). The AV1 specification was published in 2018. AOM is reportedly working on the AV2 specification.

An elementary unit for the input to a video encoder and the output of a video decoder, respectively, in most cases is a picture. A picture given as an input to an encoder may also be referred to as a source picture, and a picture decoded by a decoder may be referred to as a decoded picture or a reconstructed picture.

The source and decoded pictures are each comprises of one or more sample arrays, such as one of the following sets of sample arrays:
Luma (Y) only (monochrome),
Luma and two chroma (YCbCr or YcgCo),
Green, Blue and Red (GBR, also known as RGB),
Arrays representing other unspecified monochrome or tri-stimulus color samplings (for example, YZX, also known as XYZ).

A component may be defined as an array or single sample from one of the three sample arrays (luma and two chroma) that compose a picture, or the array or a single sample of the array that compose a picture in monochrome format.

Hybrid video codecs, for example ITU-T H.263 and H.264, may encode the video information in two phases. Firstly, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e., the difference between the predicted block of pixels and the original block of pixels, is coded. This may be done by transforming the difference in pixel values using a specified transform (e.g., Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, exploits temporal redundancy. In inter prediction the sources of prediction are previously decoded pictures.

Intra prediction utilizes the fact that adjacent pixels within the same picture are likely to be correlated. Intra prediction can be performed in spatial or transform domain, i.e., either sample values or transform coefficients can be predicted. Intra prediction may be exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means, the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

In video codecs, the motion information may be indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently, those may be coded differentially with respect to block specific predicted motion vectors. In video codecs, the predicted motion vectors may be created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index may be predicted from adjacent blocks and/or or co-located blocks in temporal reference picture. Moreover, high efficiency video codecs can employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information may be carried out using the motion field information of adjacent blocks and/or co-located blocks in temporal reference pictures and the used motion field information is signaled among a list of motion field candidate list filled with motion field information of available adjacent/co-located blocks.

In video codecs the prediction residual after motion compensation may be first transformed with a transform kernel (like DCT) and then coded. The reason for this is that often there still exists some correlation among the residual and transform can in many cases help reduce this correlation and provide more efficient coding.

Video encoders may utilize Lagrangian cost functions to find optimal coding modes, e.g., the desired coding mode for a block, block partitioning, and associated motion vectors. This kind of cost function uses a weighting factor 2 to tie together the (exact or estimated) image distortion due to lossy coding methods and the (exact or estimated) amount of information that is required to represent the pixel values in an image area:

$$C = D + λ R$$

where C is the Lagrangian cost to be minimized, D is the image distortion (e.g., Mean Squared Error) with the mode and motion vectors considered, and R the number of bits needed to represent the required data to reconstruct the image block in the decoder (including the amount of data to represent the candidate motion vectors). The rate R may be the actual bitrate or bit count resulting from encoding. Alternatively, the rate R may be an estimated bitrate or bit count. One possible way of the estimating the rate R is to omit the final entropy encoding step and use e.g., a simpler entropy encoding or an entropy encoder where some of the context states have not been updated according to previously encoding mode selections.

Conventionally used distortion metrics may comprise, but are not limited to, peak signal-to-noise ratio (PSNR), mean squared error (MSE), sum of absolute differences (SAD), sub of absolute transformed differences (SATD), and structural similarity (SSIM), typically measured between the reconstructed video/image signal (that is or would be identical to the decoded video/image signal) and the “original” video/image signal provided as input for encoding.

A partitioning may be defined as a division of a set into subsets such that each element of the set is in exactly one of the subsets.

A bitstream may be defined as a sequence of bits, which may in some coding formats or standards be in the form of a network abstraction layer (NAL) unit stream or a byte stream, which forms the representation of coded pictures and associated data forming one or more coded video sequences.

A bitstream format may comprise a sequence of syntax structures.

A syntax element may be defined as an element of data represented in the bitstream. A syntax structure may be defined as zero or more syntax elements present together in the bitstream in a specified order.

A NAL unit may be defined as a syntax structure containing an indication of the type of data to follow and bytes containing that data in the form of an RBSP interspersed as necessary with start code emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

Some coding formats specify parameter sets that may carry parameter values needed for the decoding or reconstruction of decoded pictures. A parameter may be defined as a syntax element of a parameter set. A parameter set may be defined as a syntax structure that contains parameters and that can be referred to from or activated by another syntax structure for example using an identifier.

A coding standard or specification may specify several types of parameter sets. It needs to be understood that embodiments may be applied but are not limited to the described types of parameter sets and embodiments could likewise be applied to any parameter set type.

A parameter set may be activated when it is referenced e.g., through its identifier. An adaptation parameter set (APS) may be defined as a syntax structure that applies to zero or more slices. There may be different types of adaptation parameter sets. An adaptation parameter set may for example contain filtering parameters for a particular type of a filter. In VVC, three types of APSs are specified carrying parameters for one of: adaptive loop filter (ALF), luma mapping with chroma scaling (LMCS), and scaling lists. A scaling list may be defined as a list that associates each frequency index with a scale factor for the scaling process, which multiplies transform coefficient levels by a scaling factor, resulting in transform coefficients. In VVC, an APS is referenced through its type (e.g., ALF, LMCS, or scaling list) and an identifier. In other words, different types of APSs have their own identifier value ranges.

An Adaptation Parameter Set (APS) may comprise parameters for decoding processes of different types, such as adaptive loop filtering or luma mapping with chroma scaling.

Video coding specifications may enable the use of supplemental enhancement information (SEI) messages or alike. Some video coding specifications include SEI network abstraction layer (NAL) units, and some video coding specifications contain both prefix SEI NAL units and suffix SEI NAL units, where the former type can start a picture unit or alike and the latter type can end a picture unit or alike. An SEI NAL unit contains one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified. SEI messages are generally not extended in future amendments or versions of the standard.

The phrase along the bitstream (e.g., indicating along the bitstream) or along a coded unit of a bitstream (e.g., indicating along a coded tile) may be used in claims and described embodiments to refer to transmission, signaling, or storage in a manner that the “out-of-band” data is associated with but not included within the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

Image and video codecs may use a set of filters to enhance the visual quality of the predicted visual content and can be applied either in-loop or out-of-loop, or both. In the case of in-loop filters, the filter applied on one block in the currently encoded frame will affect the encoding of another block in the same frame and/or in another frame which is predicted from the current frame. An in-loop filter can affect the bitrate and/or the visual quality. In fact, an enhanced block will cause a smaller residual (difference between original block and predicted-and-filtered block), thus requiring less bits to be encoded. An out-of-the loop filter will be applied on a frame after it has been reconstructed, the filtered visual content will not be as a source for prediction, and thus it may only impact the visual quality of the frames that are output by the decoder.

Recently, neural networks (NNs) have been used in the context of image and video compression by following mainly two approaches.

In one approach, NNs are used to replace one or more of the components of a traditional codec such as VVC/H.266. Here, term “traditional” refers to those codecs whose components and their parameters may not be learned from data. Examples of such components are:
Additional in-loop filter, for example by having the NN as an additional in-loop filter with respect to the traditional loop filters.
Single in-loop filter, for example by having the NN replacing all traditional in-loop filters.
Intra-frame prediction.
Inter-frame prediction.
Transform and/or inverse transform.
Probability model for the arithmetic codec.
Etc.

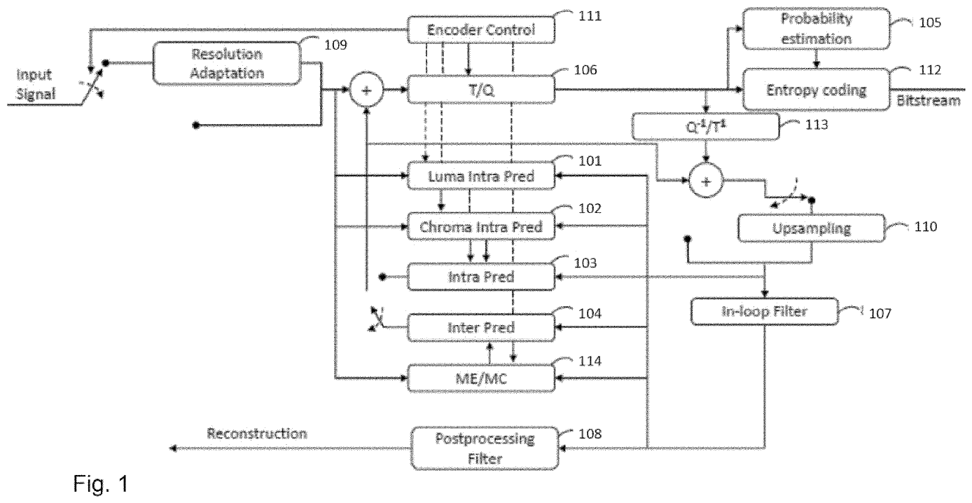

FIG. 1 illustrates examples of functioning of NNs as components of a traditional codec's pipeline, in accordance with an embodiment. In particular, FIG. 1 illustrates an encoder, which also includes a decoding loop. FIG. 1 is shown to include components described below:

A luma intra pred block or circuit 101. This block or circuit performs intra prediction in the luma domain, for example, by using already reconstructed data from the same frame. The operation of the luma intra pred block or circuit 101 may be performed by a deep neural network such as a convolutional auto-encoder.

A chroma intra pred block or circuit 102. This block or circuit performs intra prediction in the chroma domain, for example, by using already reconstructed data from the same frame. The chroma intra pred block or circuit 102 may perform cross-component prediction, for example, predicting chroma from luma. The operation of the chroma intra pred block or circuit 102 may be performed by a deep neural network such as a convolutional auto-encoder.

An intra pred block or circuit 103 and inter-pred block or circuit 104. These blocks or circuit perform intra prediction and inter-prediction, respectively. The intra pred block or circuit 103 and the inter-pred block or circuit 104 may perform the prediction on all components, for example, luma and chroma. The operations of the intra pred block or circuit 103 and inter-pred block or circuit 104 may be performed by two or more deep neural networks such as convolutional auto-encoders.

A probability estimation block or circuit 105 for entropy coding. This block or circuit performs prediction of probability for the next symbol to encode or decode, which is then provided to the entropy coding module 112, such as the arithmetic coding module, to encode or decode the next symbol. The operation of the probability estimation block or circuit 105 may be performed by a neural network.

A transform and quantization (T/Q) block or circuit 106. These are actually two blocks or circuits. The transform and quantization block or circuit 106 may perform a transform of input data to a different domain, for example, the FFT transform would transform the data to frequency domain. The transform and quantization block or circuit 106 may quantize its input values to a smaller set of possible values. In the decoding loop, there may be inverse quantization block or circuit and inverse transform block or circuit 113. One or both of the transform block or circuit and quantization block or circuit may be replaced by one or two or more neural networks. One or both of the inverse transform block or circuit and inverse quantization block or circuit 113 may be replaced by one or two or more neural networks.

An in-loop filter block or circuit 107. Operations of the in-loop filter block or circuit 107 is performed in the decoding loop, and it performs filtering on the output of the inverse transform block or circuit, or anyway on the reconstructed data, in order to enhance the reconstructed data with respect to one or more predetermined quality metrics. This filter may affect both the quality of the decoded data and the bitrate of the bitstream output by the encoder. The operation of the in-loop filter block or circuit 107 may be performed by a neural network, such as a convolutional auto-encoder. In examples, the operation of the in-loop filter may be performed by multiple steps or filters, where the one or more steps may be performed by neural networks.

A postprocessing filter block or circuit 108. The postprocessing filter block or circuit 108 may be performed only at decoder side, as it may not affect the encoding process. The postprocessing filter block or circuit 108 filters the reconstructed data output by the in-loop filter block or circuit 107, in order to enhance the reconstructed data. The postprocessing filter block or circuit 108 may be replaced by a neural network, such as a convolutional auto-encoder.

A resolution adaptation block or circuit 109: this block or circuit may downsample the input video frames, prior to encoding. Then, in the decoding loop, the reconstructed data may be upsampled, by the upsampling block or circuit 110, to the original resolution. The operation of the resolution adaptation block or circuit 109 block or circuit may be performed by a neural network such as a convolutional auto-encoder.

An encoder control block or circuit 111. This block or circuit performs optimization of encoder's parameters, such as what transform to use, what quantization parameters (QP) to use, what intra-prediction mode (out of N intra-prediction modes) to use, and the like. The operation of the encoder control block or circuit 111 may be performed by a neural network, such as a classifier convolutional network, or such as a regression convolutional network.

An ME/MC block or circuit 114 performs motion estimation and/or motion compensation, which are two key operations to be performed when performing inter-frame prediction. ME/MC stands for motion estimation/motion compensation.

In another approach, commonly referred to as “end-to-end learned compression”, NNs are used as the main components of the image/video codecs. In this second approach, there are two main options:

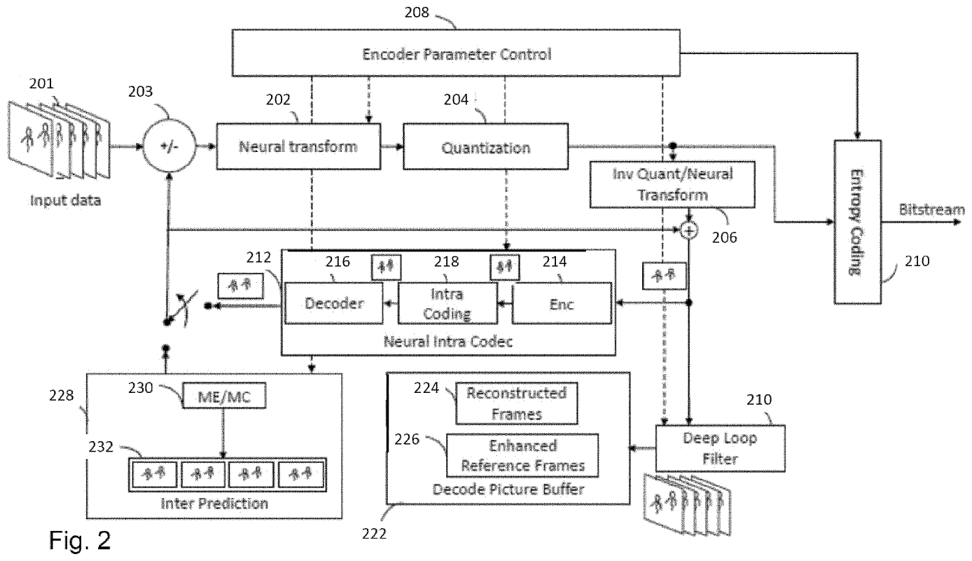

Option 1: re-use the video coding pipeline but replace most or all the components with NNs. Referring to FIG. 2, it illustrates an example of modified video coding pipeline based on a neural network, in accordance with an embodiment. An example of neural network may include, but is not limited to, a compressed representation of a neural network. FIG. 2 is shown to include following components:
A neural transform block or circuit 202: this block or circuit transforms the output of a summation/subtraction operation 203 to a new representation of that data, which may have lower entropy and thus be more compressible.
A quantization block or circuit 204: this block or circuit quantizes an input data 201 to a smaller set of possible values.
An inverse transform and inverse quantization blocks or circuits 206. These blocks or circuits perform the inverse or approximately inverse operation of the transform and the quantization, respectively.
An encoder parameter control block or circuit 208. This block or circuit may control and optimize some or all the parameters of the encoding process, such as parameters of one or more of the encoding blocks or circuits.
An entropy coding block or circuit 210. This block or circuit may perform lossless coding, for example based on entropy. One popular entropy coding technique is arithmetic coding.
A neural intra-codec block or circuit 212. This block or circuit may be an image compression and decompression block or circuit, which may be used to encode and decode an intra frame. An encoder 214 may be an encoder block or circuit, such as the neural encoder part of an auto-encoder neural network. A decoder 216 may be a decoder block or circuit, such as the neural decoder part of an auto-encoder neural network. An intra-coding block or circuit 218 may be a block or circuit performing some intermediate steps between encoder and decoder, such as quantization, entropy encoding, entropy decoding, and/or inverse quantization.
A deep loop filter block or circuit 220. This block or circuit performs filtering of reconstructed data, in order to enhance it.
A decode picture buffer block or circuit 222. This block or circuit is a memory buffer, keeping the decoded frame, for example, reconstructed frames 224 and enhanced reference frames 226 to be used for inter prediction.
An inter-prediction block or circuit 228. This block or circuit performs inter-frame prediction, for example, predicts from frames, for example, frames 232, which are temporally nearby. An ME/MC 230 performs motion estimation and/or motion compensation, which are two key operations to be performed when performing inter-frame prediction. ME/MC stands for motion estimation/motion compensation.

Option 2: re-design the whole pipeline, as follows.
Encoder NN is configured to perform a non-linear transform;
Quantization and lossless encoding of the encoder NN's output;
Lossless decoding and dequantization;
Decoder NN is configured to perform a non-linear inverse transform.

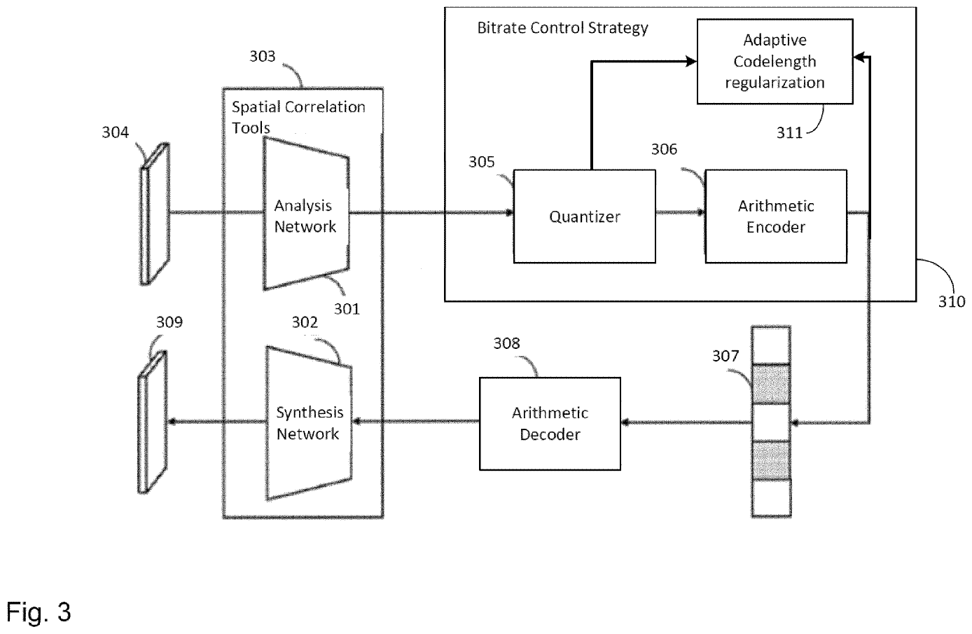

An example of option 2 is described in detail in FIG. 3 which shows an encoder NN and a decoder NN being parts of a neural auto-encoder architecture, in accordance with an example. In FIG. 3, the Analysis Network 301 is an Encoder NN, and the Synthesis Network 302 is the Decoder NN, which may together be referred to as spatial correlation tools 303, or as neural auto-encoder.

As shown in FIG. 3, the input data 304 is analyzed by the Encoder NN (Analysis Network 301), which outputs a new representation of that input data. The new representation may be more compressible. This new representation may then be quantized, by a quantizer 305, to a discrete number of values. The quantized data is then lossless encoded, for example by an arithmetic encoder 306, thus obtaining a bitstream 307. The example shown in FIG. 3 includes an arithmetic decoder 308 and an arithmetic encoder 306. The arithmetic encoder 306, or the arithmetic decoder 308, or the combination of the arithmetic encoder 306 and arithmetic decoder 308 may be referred to as arithmetic codec in some embodiments. On the decoding side, the bitstream is first lossless decoded, for example, by using the arithmetic codec decoder 308. The lossless decoded data is dequantized and then input to the Decoder NN, Synthesis Network 302. The output is the reconstructed or decoded data 309.

In case of lossy compression, the lossy steps may comprise the Encoder NN and/or the quantization.

In order to train this system, a training objective function (also called “training loss”) may be utilized, which may comprise one or more terms, or loss terms, or simply losses. In one example, the training loss comprises a reconstruction loss term and a rate loss term. The reconstruction loss encourages the system to decode data that is similar to the input data, according to some similarity metric. Examples of reconstruction losses are:
Mean squared error (MSE);
Multi-scale structural similarity (MS-SSIM);
Losses derived from the use of a pretrained neural network. For example, error (f1, f2), where f1 and f2 are the features extracted by a pretrained neural network for the input data and the decoded data, respectively, and error ( ) is an error or distance function, such as L1 norm or L2 norm;
Losses derived from the use of a neural network that is trained simultaneously with the end-to-end learned codec. For example, adversarial loss can be used, which is the loss provided by a discriminator neural network that is trained adversarially with respect to the codec, following the settings proposed in the context of Generative Adversarial Networks (GANs) and their variants.

The rate loss encourages the system to compress the output of the encoding stage, such as the output of the arithmetic encoder. “Compressing” in this context means reducing the number of bits output by the encoding stage.

When an entropy-based lossless encoder is used, such as an arithmetic encoder, the rate loss typically encourages the output of the Encoder NN to have low entropy. Example of rate losses are the following:
A differentiable estimate of the entropy;
A sparsification loss, i.e., a loss that encourages the output of the Encoder NN or the output of the quantization to have many zeros. Examples are L0 norm, L1 norm, L1 norm divided by L2 norm;
A cross-entropy loss applied to the output of a probability model, where the probability model may be a NN used to estimate the probability of the next symbol to be encoded by an arithmetic encoder.

One or more of reconstruction losses may be used, and one or more of the rate losses may be used, as a weighted sum. The different loss terms may be weighted using different weights, and these weights determine how the final system performs in terms of rate-distortion loss. For example, if more weight is given to the reconstruction losses with respect to the rate losses, the system may learn to compress less but to reconstruct with higher accuracy (as measured by a metric that correlates with the reconstruction losses). These weights may be considered to be hyper-parameters of the training session and may be set manually by the person designing the training session, or automatically for example by grid search or by using additional neural networks.

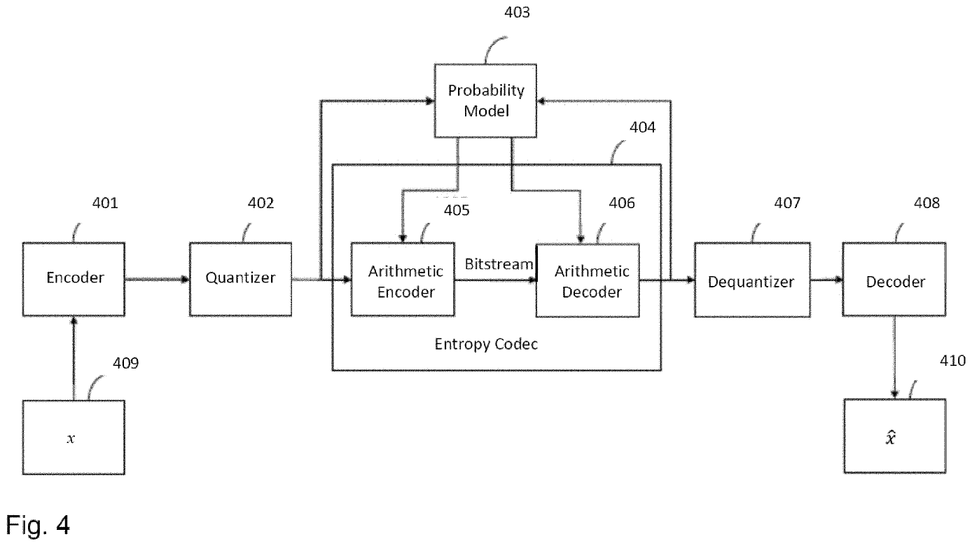

As shown in FIG. 4, a neural network-based end-to-end learned video coding system may contain an encoder 401, a quantizer 402, a probability model 403, an entropy codec 420 (for example arithmetic encoder 405/arithmetic decoder 406), a dequantizer 407, and a decoder 408. The encoder 401 and decoder 408 may be two neural networks, or mainly comprise neural network components. The probability model 403 may also comprise mainly neural network components. Quantizer 402, dequantizer 407 and entropy codec 420 may not be based on neural network components, but they may also comprise neural network components, potentially.

On the encoder side, the encoder component 401 takes a video x 409 as input and converts the video from its original signal space into a latent representation that may comprise a more compressible representation of the input. In the case of an input image, the latent representation may be a 3-dimensional tensor, where two dimensions represent the vertical and horizontal spatial dimensions, and the third dimension represent the “channels” which contain information at that specific location. If the input image is a 128×128×3 RGB image (with horizontal size of 128 pixels, vertical size of 128 pixels, and 3 channels for the Red, Green, Blue color components), and if the encoder downsamples the input tensor by 2 and expands the channel dimension to 32 channels, then the latent representation is a tensor of dimensions (or “shape”) 64×64×32 (i.e., with horizontal size of 64 elements, vertical size of 64 elements, and 32 channels). Please note that the order of the different dimensions may differ depending on the convention which is used; in some cases, for the input image, the channel dimension may be the first dimension, so for the above example, the shape of the input tensor may be represented as 3×128×128, instead of 128×128×3. In the case of an input video (instead of just an input image), another dimension in the input tensor may be used to represent temporal information.

The quantizer component 402 quantizes the latent representation into discrete values given a predefined set of quantization levels. Probability model 403 and arithmetic codec component 420 work together to perform lossless compression for the quantized latent representation and generate bitstreams to be sent to the decoder side. Given a symbol to be encoded into the bitstream, the probability model 403 estimates the probability distribution of all possible values for that symbol based on a context that is constructed from available information at the current encoding/decoding state, such as the data that has already been encoded/decoded. Then, the arithmetic encoder 405 encodes the input symbols to bitstream using the estimated probability distributions.

On the decoder side, opposite operations are performed. The arithmetic decoder 406 and the probability model 403 first decode symbols from the bitstream to recover the quantized latent representation. Then the dequantizer 407 reconstructs the latent representation in continuous values and pass it to decoder 408 to recover the input video/image. Note that the probability model 403 in this system is shared between the encoding and decoding systems. In practice, this means that a copy of the probability model 403 is used at encoder side, and another exact copy is used at decoder side.

In this system, the encoder 401, probability model 403, and decoder 408 may be based on deep neural networks. The system may be trained in an end-to-end manner by minimizing the following rate-distortion loss function:

$$L = D + λ R ,$$

where D is the distortion loss term, R is the rate loss term, and A is the weight that controls the balance between the two losses. The distortion loss term may be the mean square error (MSE), structure similarity (SSIM) or other metrics that evaluate the quality of the reconstructed video. Multiple distortion losses may be used and integrated into D, such as a weighted sum of MSE and SSIM. The rate loss term is normally the estimated entropy of the quantized latent representation, which indicates the number of bits necessary to represent the encoded symbols, for example, bits-per-pixel (bpp).

For lossless video/image compression, the system may contain only the probability model 403 and arithmetic encoder/decoder 405, 406. The system loss function contains only the rate loss, since the distortion loss is always zero (i.e., no loss of information).

Reducing the distortion in image and video compression is often intended to increase human perceptual quality, as humans are considered to be the end users, i.e., consuming/watching the decoded image. Recently, with the advent of machine learning, especially deep learning, there is a rising number of machines (i.e., autonomous agents) that analyze data independently from humans and that may even take decisions based on the analysis results without human intervention. Examples of such analysis are object detection, scene classification, semantic segmentation, video event detection, anomaly detection, pedestrian tracking, etc. Example use cases and applications are self-driving cars, video surveillance cameras and public safety, smart sensor networks, smart TV and smart advertisement, person re-identification, smart traffic monitoring, drones, etc. When the decoded data is consumed by machines, a different quality metric shall be used instead of human perceptual quality. Also, dedicated algorithms for compressing and decompressing data for machine consumption are likely to be different than those for compressing and decompressing data for human consumption. The set of tools and concepts for compressing and decompressing data for machine consumption is referred to here as Video Coding for Machines (VCM).

VCM concerns the encoding of video streams to allow consumption for machines. Machine is referred to indicate an algorithm or system or other entity which takes a video or image or a signal derived from a video or image as input in order to perform a task, or a device that comprises such algorithm or system or other entity. Examples of a machine can be a neural network based classifier, a mobile phone, an autonomous vehicle, a robot, and such intelligent devices which may have a degree of autonomy or run an intelligent algorithm to process the decoded stream beyond reconstructing the original input stream.

A machine may perform one or multiple tasks on the decoded stream. Examples of tasks can comprise the following:
Classification: classify an image or video into one or more predefined categories. The output of a classification task may be a set of detected categories, also known as classes or labels. The output may also include the probability and confidence of each predefined category.
Object detection: detect one or more objects in a given image or video. The output of an object detection task may be the bounding boxes and the associated classes of the detected objects. The output may also include the probability and confidence of each detected object.
Instance segmentation: identify one or more objects in an image or video at the pixel level. The output of an instance segmentation task may be binary mask images or other representations of the binary mask images, e.g., closed contours, of the detected objects. The output may also include the probability and confidence of each object for each pixel.
Semantic segmentation: assign the pixels in an image or video to one or more predefined semantic categories. The output of a semantic segmentation task may be binary mask images or other representations of the binary mask images, e.g., closed contours, of the assigned categories. The output may also include the probability and confidence of each semantic category for each pixel.
Object tracking: track one or more objects in a video sequence. The output of an object tracking task may include frame index, object ID, object bounding boxes, probability, and confidence for each tracked object.
Captioning: generate one or more short text descriptions for an input image or video. The output of the captioning task may be one or more short text sequences.
Human pose estimation: estimate the position of the key points, e.g., wrist, elbows, knees, etc., from one or more human bodies in an image of the video. The output of a human pose estimation includes sets of locations of each key point of a human body detected in the input image or video.
Human action recognition: recognize the actions, e.g., walking, talking, shaking hands, of one or more people in an input image or video. The output of the human action recognition may be a set of predefined actions, probability, and confidence of each identified action.
Anomaly detection: detect abnormal object or event from an input image or video. The output of an anomaly detection may include the locations of detected abnormal objects or segments of frames where abnormal events detected in the input video.

It is likely that the receiver-side device has multiple “machines” or task neural networks (Task-NNs). These multiple machines may be used in a certain combination which is for example determined by an orchestrator sub-system. The multiple machines may be used for example in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

In this description, “task machine” and “machine” and “task neural network” are referred to interchangeably, and for such referral any process or algorithm (learned or not from data) which analyzes or processes data for a certain task is meant. In the rest of the description, other assumptions made regarding the machines considered in this disclosure may be specified in further details. Also, term “receiver-side” or “decoder-side” are used to refer to the physical or abstract entity or device, which may contain one or more machines, and may run these one or more machines on an encoded and eventually decoded video representation which is encoded by another physical or abstract entity or device, the “encoder-side device”.

The encoded video data may be stored into a memory device, for example as a file. The stored file may later be provided to another device. Alternatively, the encoded video data may be streamed from one device to another.

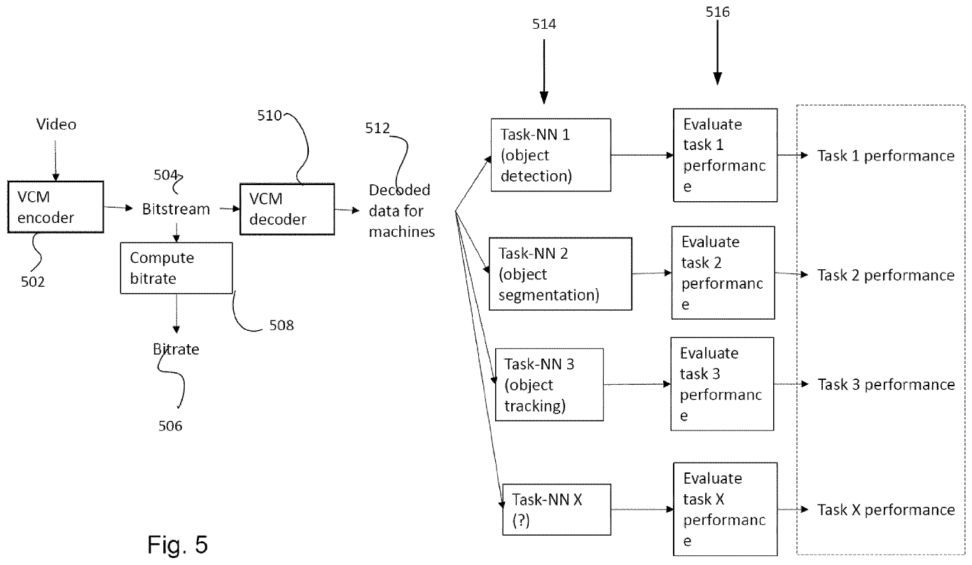

FIG. 5 is a general illustration of the pipeline of Video Coding for Machines. A VCM encoder 502 encodes the input video into a bitstream 504. A bitrate 506 may be computed 508 from the bitstream 504 in order to evaluate the size of the bitstream. A VCM decoder 510 decodes the bitstream output by the VCM encoder 502. In FIG. 5, the output of the VCM decoder 510 is referred to as “Decoded data for machines” 512. This data may be considered as the decoded or reconstructed video. However, in some implementations of this pipeline, this data may not have same or similar characteristics as the original video which was input to the VCM encoder 502. For example, this data may not be easily understandable by a human when rendering the data onto a screen. The output of VCM decoder is then input to one or more task neural networks 514. In the figure, for the sake of illustrating that there may be any number of task-NNs 514, there are three example task-NNs, and a non-specified one (Task-NN X). The goal of VCM is to obtain a low bitrate representation of the input video while guaranteeing that the task-NNs still perform well in terms of the evaluation metric 516 associated to each task.

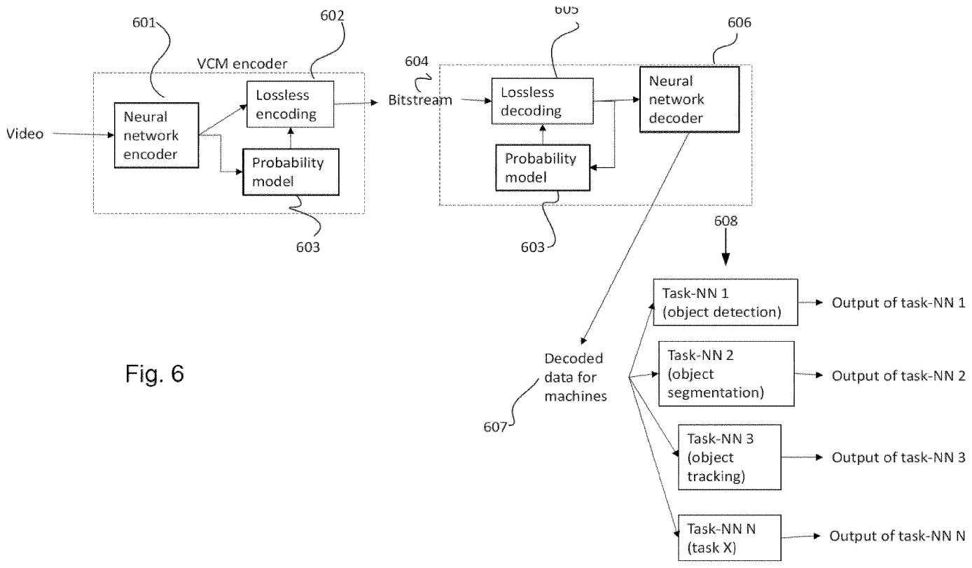

One of the possible approaches to realize video coding for machines is an end-to-end learned approach. In this approach, the VCM encoder and VCM decoder mainly consist of neural networks. FIG. 6 illustrates an example of a pipeline for the end-to-end learned approach. The video is input to a neural network encoder 601. The output of the neural network encoder 601 is input to a lossless encoder 602, such as an arithmetic encoder, which outputs a bitstream 604. The output of the neural network encoder 601 may be input also to a probability model 603 which provides to the lossless encoder 602 with an estimate of the probability of the next symbol to be encoded by the lossless encoder 602. The probability model 603 may be learned by means of machine learning techniques, for example it may be a neural network. At decoder-side, the bitstream 604 is input to a lossless decoder 605, such as an arithmetic decoder, whose output is input to a neural network decoder 606. The output of the lossless decoder 605 may be input to a probability model 603, which provides the lossless decoder 605 with an estimate of the probability of the next symbol to be decoded by the lossless decoder 605. The output of the neural network decoder 606 is the decoded data for machines 607, that may be input to one or more task-NNs 608.

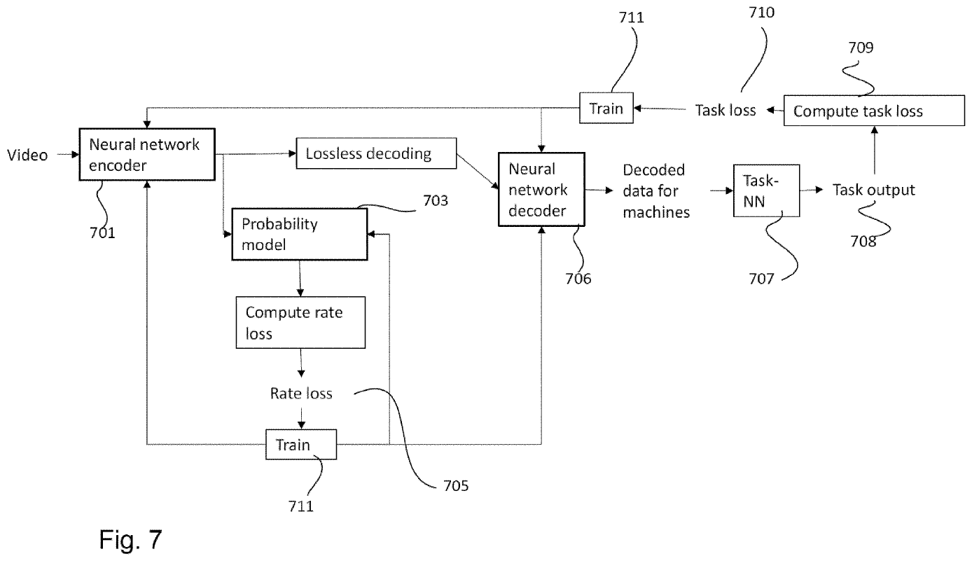

FIG. 7 illustrates an example of how the end-to-end learned system may be trained for the purpose of video coding for machines. For the sake of simplicity, only one task-NN 707 is illustrated. A rate loss 705 may be computed from the output of the probability model 703. The rate loss 705 provides an approximation of the bitrate required to encode the input video data. A task loss 710 may be computed 709 from the output 708 of the task-NN 707.

The rate loss 705 and the task loss 710 may then be used to train 711 the neural networks used in the system, such as the neural network encoder 701, the probability model 703, the neural network decoder 706. Training may be performed by first computing gradients of each loss with respect to the trainable neural networks' parameters that are contributing or affecting the computation of that loss. The gradients are then used by an optimization method, such as Adam, for updating the trainable parameters of the neural networks.

The machine tasks may be performed at decoder side (instead of at encoder side) for multiple reasons, for example because the encoder-side device does not have the capabilities (computational, power, memory) for running the neural networks that perform these tasks, or because some aspects or the performance of the task neural networks may have changed or improved by the time that the decoder-side device needs the tasks results (e.g., different or additional semantic classes, better neural network architecture). Also, there could be a customization need, where different clients would run different neural networks for performing these machine learning tasks.

Dense Split Attention (DSA) block is an attention block that estimates one or more attention maps, and applies the one or more attention maps to one or more data tensors.
Where an attention map may be a vector, a matrix or a tensor. In one example, an attention map may have values in the range [0, 1].
Where the one or more data tensors may comprise one or more input tensor to the attention block, and/or one or more feature maps that are extracted within the attention block, and/or one or more feature maps that are extracted outside of the attention block.
Where the application of the one or more attention maps to the one or more data tensors may comprise multiplying the one or more attention maps by the one or more data tensors, for example by using element-wise multiplication operation. Other operations may be also considered.

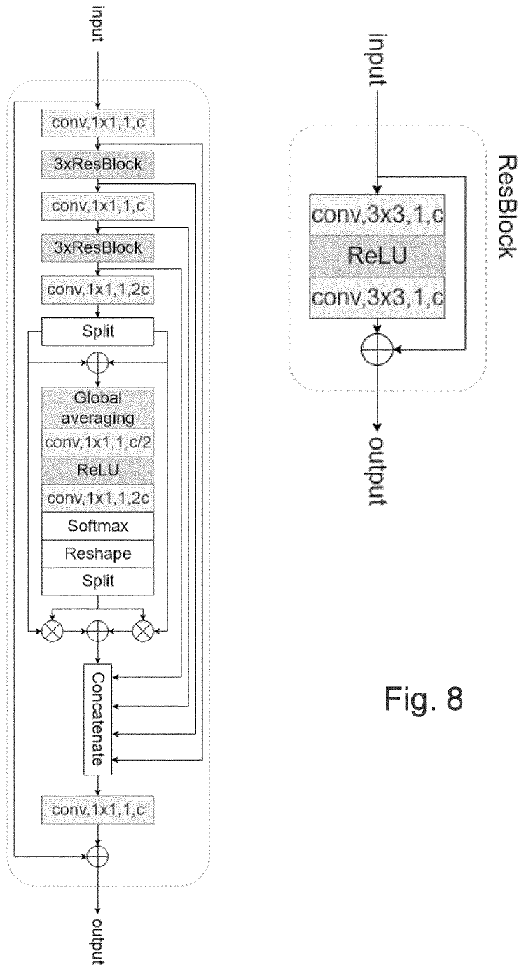

FIG. 8 illustrates an example of a DSA block, where one type of NN layer is a ResBlock, which comprises NN layers.

The DSA block may comprise extracting features from its input based at least on one or more initial NN layers, then splitting the extracted features across the channel axis to obtain two split features, summing up the split features, performing a global averaging operation on the summed features, processing the output of the global averaging operation based at least on one or more NN layers, inputting the result of this processing to a Softmax operation, splitting the result of the Softmax operation across the channel axis to obtain two attention tensors, multiplying the two attention tensors with the previously determined two split features to obtain two attended split features, summing up the two attended split features, concatenate the summed attended split features with features determined based at least on the one or more initial NN layers, processing the result of the concatenation by means of at least one or more NN layers, summing the output of this processing with the input of the DSA block, to obtain the output of the DSA block. Here, the global averaging operation may be a global pooling (an average pooling) operation that calculates the average value for patches of a feature map. It can aggregate spatial information of a feature map to a single channel, to help exploit the inter-channel relationship of features.

In video coding, video and image samples are typically encoded using color representations such as YUV or YCbCr consisting of one luminance (luma) channel, also denoted as Y, and two chrominance (chroma) channels, also denoted as U, V or as Cb, Cr. In these cases the luminance channel, representing mostly the illumination of the scene, is typically coded at certain resolution, while the chrominance channels, representing typically differences between certain color components, are often coded at a second resolution lower than that of the luminance signal. The intention of this kind of a differential representation is to decorrelate the color components and be able to compress the data more efficiently.

As mentioned above, neural networks (NNs) have been used in the context of image and video compression by replacing one or more of the components of a traditional codec, as shown in FIG. 1, or utilizing the end-to-end learned compression, as shown in FIGS. 2 and 3. However, the NN-based video coding approaches, including the solutions based on the end-to-end learned compression, have shown to be difficult to optimize in terms of rate-distortion performance.

Now methods for improving the rate-distortion performance of NN-based video codecs are introduced.

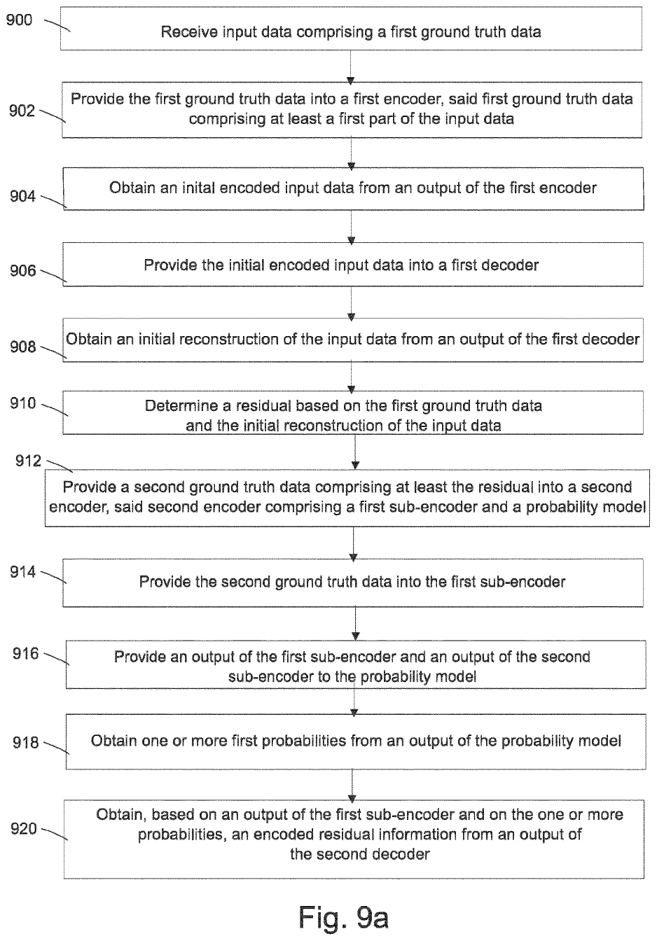

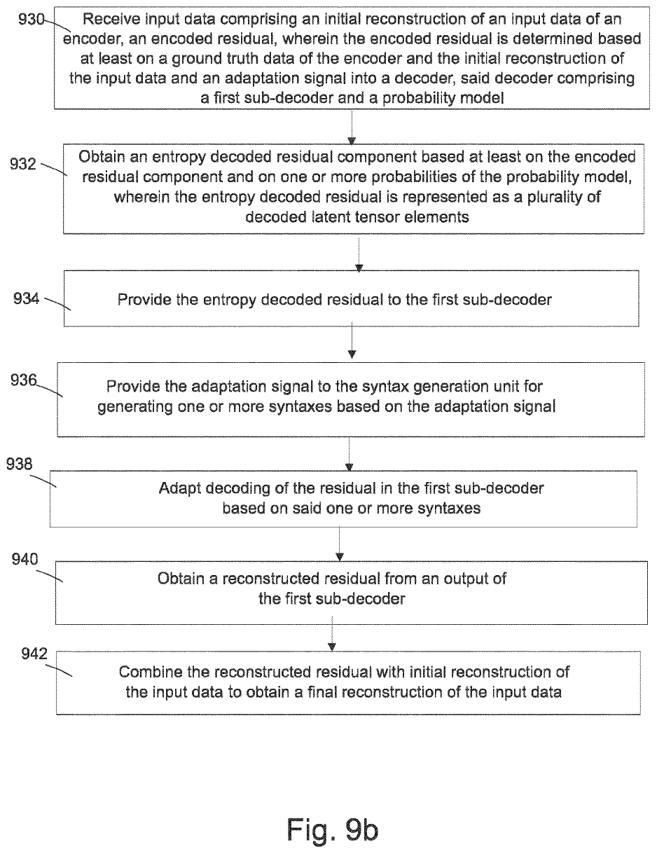

An encoding method according to an aspect is shown in FIG. 9a, where the method comprises receiving (900) input data comprising a first ground truth; providing (902) the first ground truth data into a first encoder, said ground truth data comprising at least a first part of the input data; obtaining (904) an initial encoded input data from an output of the first encoder; providing (906) the initial encoded input data into a first decoder; obtaining (908) an initial reconstruction of the input data from an output of the first decoder; determining (910) a residual based at least on the first ground truth data and on the initial reconstruction; providing (912) the second ground truth data comprising at least the residual into a second encoder, said second encoder comprising at least a first sub-encoder and a probability model; providing (914) the second ground truth data into the first sub-encoder; providing (916) an output of the first sub-encoder to the probability model; obtaining (918) one or more first probabilities from an output of the probability model; and obtaining (920), based on an output of the first sub-encoder and on the one or more probabilities, an encoded residual information from an output of the second encoder.

A decoding method according to an aspect is shown in FIG. 9b, where the method comprises receiving (930) input data comprising an initial reconstruction of an input data of an encoder, an encoded residual, said encoded residual being determined based at least on a ground truth data of the encoder and the initial reconstruction of the input data and an adaptation signal into a decoder, said decoder comprising at least a first sub-decoder, a syntax generation unit and a probability model; obtaining (932) an entropy decoded residual based at least on the encoded residual and on one or more probabilities of the probability model, wherein the entropy decoded residual is represented as a plurality of decoded latent tensor elements; providing (934) the entropy decoded residual to the first sub-decoder; providing (936) the adaptation signal to the syntax generation unit for generating one or more syntaxes based on the adaptation signal; adapting (938) decoding of the residual in the first sub-decoder based on said one or more syntaxes; obtaining (940) a reconstructed residual from an output of the first sub-decoder; and combining (942) the reconstructed residual with initial reconstruction of the input data to obtain a final reconstruction of the input data.

Thus, the methods reflect the encoding and decoding aspects in a codec comprising two separate codecs to code the input data, a first codec comprising a first encoder and a first decoder and a second codec comprising a second encoder and a second decoder. These two codecs may be referred to as a first-step codec and a second-step codec, respectively. The encoder of first-step codec may take the ground-truth data as an input and may output a first bitstream, and the decoder of first-step codec decodes the first bitstream and outputs an initial reconstruction of the input data (ground truth data). Internally, the decoder of first-step codec obtains an adaptation signal, such as a latent tensor or a dequantized latent tensor, based at least on the first bitstream. Then, a residual is computed based on the ground truth data and the initial reconstruction of the ground truth data. The encoder of the second-step codec takes the residual and outputs a second bitstream representing an encoded residual information.

The decoder of second-step codec takes the second bitstream (i.e. the encoded residual information) and the adaptation signal, such as the dequantized latent tensor, from first-step codec as an input. The adaptation signal, such as the dequantized latent tensor of first-step codec, may be input to the decoder of second-step codec to adapt the decoding of residual information. Thus, the latent tensor or dequantized latent tensor may also be referred to as an adaptation signal or as an embedded syntax. Finally, the reconstructed residual from the second-step codec is combined with the initial reconstruction of the ground truth data from the first-step codec to get the final reconstruction of the ground truth. The sum of the bitstream output by the encoder of first-step codec (i.e. the first bitstream) and the bitstream output by the encoder of second-step codec (i.e. the second bitstream) represents the encoded ground truth.

With the adaptation signal, a.k.a. the embedded syntax (e.g., the (dequantized) latent tensor), determined by the first-step codec, the decoder of second-step codec can be adapted based on one or more aspects or features of input data, which may improve the rate-distortion performance of the second-step codec. Therefore, the rate-distortion performance of the whole codec (the combination of the first-step codec and the second-step codec) may be improved.

According to an embodiment, the first and the second encoders and decoders belong to an end-to-end learned intra-frame codec, or an end-to-end learned image codec.

Thus, the improvements of the rate-distortion performance are achievable with learned video compression, especially in the context of end-to-end learned intra-frame codec. However, it is noted that the method and the related embodiments are also applicable to end-to-end learned inter-frame codecs.

According to an embodiment, the learned intra-frame codec is trained in an end-to-end manner by minimizing D+AR, where D is a distortion loss term, R is a rate loss term, and A is a weight controlling a balance between said losses.

The distortion loss term may be computed based at least on a distortion function, on a ground-truth data, and on an output of the decoder comprised in the learned intra-frame codec.

The rate loss term may be computed based at least on an estimate of the bitrate of a bitstream (e.g., size of that bitstream in bits) output of the encoder comprised in the learned intra-frame codec.

This optimization process results in a so-called rate-distortion trade-off, where a balance is found between the distortion D and the rate loss R. The rate loss may indicate a bitrate of the encoded image, and the distortion may indicate a pixel fidelity distortion such as the following:
Mean-squared error (MSE);
Multi-scale structural similarity (MS-SSIM);
Multiple distortion losses, such as a weighted sum of MSE and MS-SSIM;
Other metrics that evaluate the quality of the reconstructed image.

According to an embodiment, the distortion may be related to a performance of one or more machine analysis tasks or to an estimated performance of one or more machine analysis tasks, where the one or more machine analysis tasks may comprise object detection, image segmentation, instance segmentation, etc., In one example, the estimated performance of one or more machine analysis tasks may comprise a distortion computed based at least on a first set of features extracted from an output of the decoder and a second set of features extracted from a respective ground truth data, where the first set of features and the second set of features are output by one or more layers of a pretrained feature-extraction neural network.

According to an embodiment, training of the learned intra-frame codec is performed jointly with respect to the distortion loss D and the rate loss R.

According to another embodiment, training of the learned intra-frame codec is performed in two alternating phases, where in a first phase of the two alternating phases only the distortion loss D is used, and in a second phase of the two alternating phases only the rate loss R is used.

In the following, various embodiments relating to the implementation options are described. It is noted that the terms “intra frame”, “frame” and “image” may be used interchangeably. These terms may refer to the input data to an end-to-end (e2e) learned intra-frame codec. For the sake of simplicity, in at least some of the embodiments, image is considered as the data type. However, the embodiments and their underlying principles described herein may be extended to other types of data, such as video, audio, etc. Additionally, in at least some of the embodiments, YUV is considered as the input color format. However, the embodiments may equally be extended to other color formats, such as RGB. In YUV format, ‘Y’ represents the brightness, or ‘luma’ value; and ‘U’ and ‘V’ represent the color, or ‘chroma’ values. In one example, the input image may be an image in YUV 4:4:4 color format, represented as a 3-dimensional array (or tensor) with size 256×256×3, where the horizontal size is 256 pixels, vertical size is 256 pixels, and 3 channels are for Y, U, V components, respectively. In another example, the input image may be an image in YUV 4:2:0 color format, represented by the combination of a matrix of size 256×256 for the luma component and of a 2-dimensional array (or tensor) of size 128×128×2 for the chroma component.

In general, an e2e learned intra-frame codec resembles an e2e learned image compression system. Typically, it may consist of image encoder, quantizer, probability model, entropy codec (for example arithmetic encoder/decoder), dequantizer, and image decoder. The image encoder, probability model, and image decoder may mainly comprise neural network components. The quantizer, entropy codec, and dequantizer are typically not based on neural network components, but they may nevertheless comprise neural network components.

An e2e learned intra-frame codec may be used as part of a video codec, where the intra-frame codec may code each of one or more first frames of a video independently from any other frame, and where another codec termed inter-frame codec may code each of one or more second frames of a video based at least on one or more other frames, for example based at least on data derived from the one or more first frames. While embodiments described herein refer to an end-to-end learned intra-frame codec, at least some embodiments described herein may also be applied to an end-to-end learned inter-frame codec used for video compression, or to an end-to-end learned video codec that compresses both intra and inter frames.

### First-Step Codec

The input to the first-step codec may comprise at least a ground truth data (e.g. a block or whole image), where at least part of the ground truth data is to be encoded/compressed. In addition, the input may comprise one or more extra data, such as block/image resolution. Examples of input ground truth data are the following:
A ground truth. For example, the ground truth may be an image in YUV 4:4:4 color format, represented as a 256×256×3 multi-dimensional array or tensor, where the horizontal size is 256 pixels, vertical size is 256 pixels, and 3 channels are for Y, U, V components, respectively. In another example, the ground truth may be an image in YUV 4:2:0 color format, represented by the combination of a matrix of size 256×256 for the luma component and of a 2-dimensional array (or tensor) of size 128×128×2 for the chroma component. In another example, the ground truth may include luma component only, represented as a 1-dimensional array (or tensor) with size 256×256×1. In another example, the ground truth may include chroma component only, represented as a 2-dimensional array (or tensor) with size 128×128×2.
Partial ground truth. For example, the input data may be the result of ground truth multiplied with a mask or an output of gaussian filter.

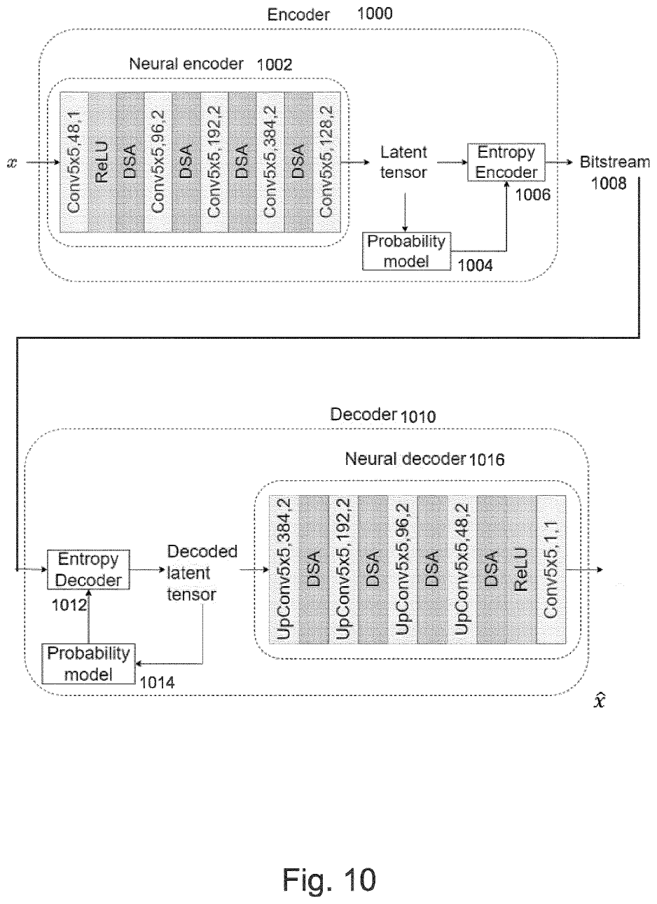

FIG. 10 illustrates an example implementation of first-step codec according to an embodiment. The input data x is a ground truth, herein including both luma component and chroma component of an image, and h×w×3 denotes the size of x with height h, width w and number of channels 3. The first-step codec is used to code the input data; i.e., the bitstream that is output by the encoder of the first-step codec represents an initial encoded input data, and the output of the decoder of the first-step codec represents the initial reconstruction of the input data.

The encoder 1000 of first-step codec may comprise a neural encoder 1002, a quantizer, a probability model 1004 and an entropy encoder 1006. In the figure, the quantizer is not illustrated for simplicity. The neural encoder 1002 may comprise a first convolutional layer (′Conv5×5, 48, 1′, where conv stands for convolution, 5×5 is the kernel size, 48 is the number of output channels, and 1 is the stride value), followed by a non-linear activation function ReLU, followed by a first DSA block, followed by a second convolutional layer, followed by a second DSA block, followed by a third convolutional layer, followed by a third DSA block, followed by a fourth convolutional layer, followed by a fourth DSA block, followed by a fifth convolutional layer. The neural encoder 1002 outputs a latent tensor, which may be quantized. The latent tensor or a quantized latent tensor may be input to a probability model 1004, and the dimension of the latent tensor may be h//16×w//16×128, where h//16 indicates the height, w//16 indicates the width, and 128 indicates the number of channels of the latent tensor. The probability model outputs an estimate of the probability of each element of the (quantized) latent tensor. The probability model may be learned from data by using machine learning techniques; for example, the probability model may be a neural network. At encoder side, the output of the probability model 1004 is used as one of the inputs to an entropy encoder 1006. The entropy encoder may be an arithmetic encoder. The entropy encoder takes in at least the (quantized) latent tensor and the output of the probability model and outputs a bitstream 1008.

The decoder 1010 of first-step codec may comprise an entropy decoder 1012, a probability model 1014, a dequantizer and a neural decoder 1016. In the figure, the dequantizer is not illustrated for simplicity. The probability model 1014 and the probability model 1004 are assumed to be same or substantial same; for example, they can be copies of the same probability model. The entropy decoder 1012 may be an arithmetic decoder. The entropy decoder takes in at least the bitstream 1008 and the output of the probability model 1014, and outputs a (quantized) decoded latent tensor. The decoded latent tensor may undergo dequantization. The decoded latent tensor or the dequantized decoded latent tensor is then input to the neural decoder 1016. The neural decoder may comprise a first transpose convolutional layer (′UpConv5×5, 384, 2′, where UpConv refers to transpose convolution, 5×5 is the kernel size, 384 is the number of output channels, and 2 is the stride value), a first DSA block, a second transpose convolutional layer, a second DSA block, a third transpose convolutional layer, a third DSA block, a fourth transpose convolutional layer, a fourth DSA block, a non-linear activation function ReLU, and a convolutional layer.

The output & of the neural decoder 1016 comprises an initial reconstruction of the input data x, where the size may be h×w×3.

### Second-Step Codec

The second-step codec is used to code the residual of the ground truth, where the residual may be computed based on ground truth data (e.g. a block or whole image) and the initial reconstruction \hat{x} from the first-step codec. The input to the second-step codec may comprise at least the residual. In addition, the input to the second-step codec may comprise one or more extra data, such as block/image resolution. Examples of input ground truth data are the following:

The residual between the ground truth and the initial reconstruction x from the first-step codec. For example, the ground truth may be an image in YUV 4:4:4 color format, represented as a 256×256×3 multi-dimensional array or tensor, where the horizontal size is 256 pixels, vertical size is 256 pixels, and 3 channels are for Y, U, V components, respectively. The output x of the first-step codec represents an initial reconstruction of the ground truth, where the size may be 256×256×3, whereupon the residual may be the difference between the ground truth and reconstruction x, whose size may be also 256×256×3.

According to an embodiment, the input data to the second-step codec may comprise the output of the first-step codec. Thus, input data may comprise the initial reconstruction x from decoder of the first-step codec, e.g. in addition to the residual between the ground truth and the initial reconstruction x from the first-step codec. The residual may also be computed in the second-step codec, e.g. in the encoder of the second-step codec.

The residual may be computed, for example, as a sample-wise difference between the ground truth data and the initial reconstruction from the first-step codec.

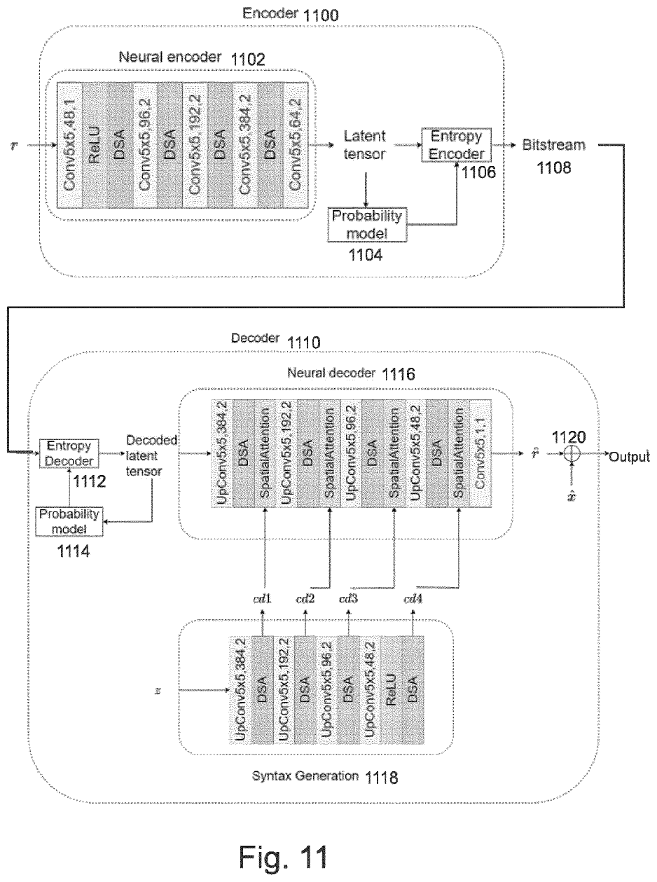

FIG. 11 illustrates an example implementation of second-step codec according to an embodiment. The input data r is the residual between the ground truth and the initial reconstruction x from the first-step codec, and h×w×3 denotes the size of x, with height h, width w and number of channels 3. The second-step codec is used to code the residual information; i.e., the bitstream that is output by the encoder of the second-step codec represents the encoded residual information, and the output of the decoder represents the reconstructed residual. To clarify, the bitstream from the first-step codec and the bitstream from the second-step codec would represent the encoded ground truth, and a combination (e.g., a sample-wise sum) of the initial reconstruction from first-step codec and the reconstructed residual from the second-step codec would represent the final reconstructed ground truth.

The encoder 1100 of the second-step codec may comprise a neural encoder (i.e. the first sub-encoder) 1102, a quantizer (not shown in the figure), a probability model 1104 and an entropy encoder 1106. Similar to the neural encoder 1002 of first-step codec, the neural encoder 1102 of second-step codec may also comprise a first convolutional layer, a non-linear activation function ReLU, a first DSA block, a second convolutional layer, a second DSA block, a third convolutional layer, a third DSA block, a fourth convolutional layer, a fourth DSA block, and a fifth convolutional layer. The dimension of latent tensor would be h//16×w//16×128, where the height is h//16, the width is w//16, and the number of channels is 128.

The (quantized) latent tensor that is output by the encoder 1102 of the second-step codec may be input to the probability model. The probability model 1104 may be a neural network. The probability model 1104 outputs an estimate of the probability of one or more elements of the latent tensor. At encoder side, the output of the probability model 1104 is used as one of the inputs to an entropy encoder 1106. The entropy encoder may be an arithmetic encoder. The entropy encoder 1106 takes in at least the (quantized) latent tensor and the output of the probability model 1106 and outputs a bitstream 1108 that represents the encoded residual information.

The decoder 1110 of the second-step codec may comprise an entropy decoder 1112, a probability model 1114, a dequantizer (not shown in the figure), a neural decoder 1116 and a syntax generation network 1118. The entropy decoder 1112 may be an arithmetic decoder. The entropy decoder 1112 takes in at least the bitstream 1108 and the output of the probability model 1114, and outputs a decoded (quantized) latent tensor. The probability model 1114 may need to be the same or substantially the same probability model 1104 that is available at encoder side. The decoded (quantized) latent tensor may undergo dequantization. After dequantization, the dequantized decoded latent tensor is input to the neural decoder 1116. The neural decoder 1116 may comprise a first transpose convolutional layer, a first DSA block, a second transpose convolutional layer, a second DSA block, a third transpose convolutional layer, a third DSA block, a non-linear activation function ReLU, and a convolutional layer.

The syntax generation network 1118 may take an adaptation signal as an input z and may generate one or more syntaxes. The syntax may be, for example, a tensor. According to an embodiment, the adaptation signal input to the syntax generation network is derived based at least on the first bitstream, i.e., on the bitstream that is input to the decoder of the first-step codec. According to an embodiment, the adaptation signal input to the syntax generation network is the dequantized latent tensor from the first-step codec.

The syntax generation network 1118 may comprise a first transpose convolutional layer (UpConv), a first DSA block, a second transpose convolutional layer, a second DSA block, a third transpose convolutional layer, a third DSA block, a fourth transpose convolutional layer, a non-linear activation function ReLU, and a fourth DSA block. After each DSA block, there may be one generated syntax, cd1, cd2, cd3 and cd4, respectively. Then, the generated syntax cd1, cd2, cd3 and cd4 may be respectively injected into the first Spatial Attention block, the second Spatial Attention block, the third Spatial Attention block and the fourth Spatial Attention block in the neural decoder 1116.

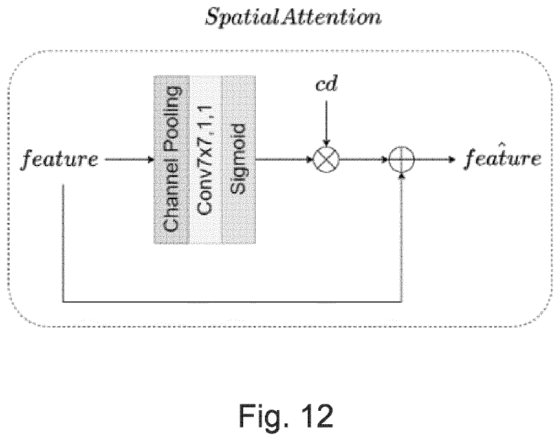

FIG. 12 shows an example of the Spatial attention block. In each Spatial Attention block, the feature extracted from the DSA block of the neural decoder may undergo a channel pooling operation, a convolutional layer, and a non-linear activation function Sigmoid. Then the output may multiply with the injected syntax cd, and the feature extracted from the DSA block of the neural decoder is added to it to get the refined feature

[symbol]

With the injection of syntax, the output of the neural decoder 1116 is a reconstruction of residual information, and the size may be h×w×3. Finally, the reconstructed residual is added in a combiner 1120 to the initial reconstruction x, to get the final reconstruction.

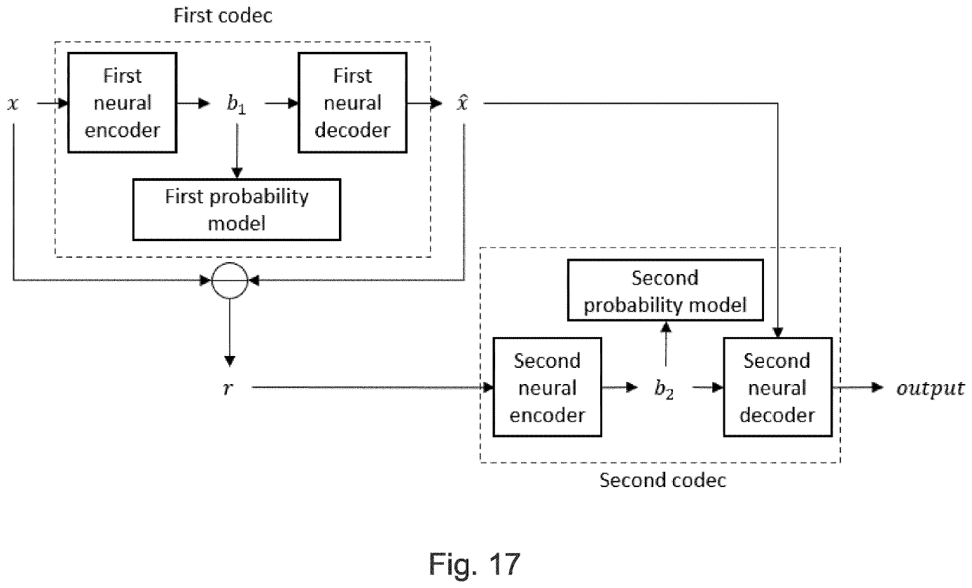

According to an embodiment, the output of the second decoder is the final reconstruction of the input data. Thus, the initial reconstruction x is omitted, i.e. it is not considered at all, or it is considered as zero in the combiner 1120, or the combiner 1120 may not be present in the second codec. As a result, the output of the second decoder is the final reconstruction of the input data. This embodiment is also illustrated in FIG. 17.

According to an embodiment, the adaptation signal input to the syntax generation network is the initial reconstruction of ground truth data obtained from the output of the first-step codec.

According to an embodiment, the intra-frame codec includes an auxiliary encoder at the decoder side, wherein the adaptation signal input to the syntax generation network is an output of the auxiliary encoder.

Since the first-step codec contains sufficient spatial information of the input data, the generated syntax may provide spatial information to the neural decoder of second-step codec to adapt the reconstruction of the residual part based on the contents.

The above presented methods relating to the encoding and decoding aspects may be implemented in respective encoding and decoding apparatus. An apparatus according to an aspect comprises means for receiving input data comprising a first ground truth data; means for providing the first ground truth data into a first encoder, said ground truth data comprising at least a first part of the input data; means for obtaining an initial encoded input data from an output of the first encoder; means for providing the initial encoded input data into a first decoder; means for obtaining an initial reconstruction of the input data from an output of the first decoder; means for determining a residual based at least on the first ground truth data and the initial reconstruction of the input data; means for providing a second ground truth data comprising at least the residual into a second encoder, said second encoder comprising at least a first sub-encoder for the second ground truth data and a probability model; means for providing the second ground truth data into the first sub-encoder; means for providing an output of the first sub-encoder to the probability model; means for obtaining one or more first probabilities from an output of the probability model; and means for obtaining, based on the output of the first sub-encoder and on the one or more probabilities, an encoded residual information from an output of the second encoder.

According to an embodiment, the first encoder, the first decoder and the second encoder belong to an end-to-end learned intra-frame codec.

According to an embodiment, said first encoder comprises a neural encoder, a probability model and an entropy encoder; the neural encoder comprising means for converting the input data into a plurality of latent tensor elements; the probability model comprising means for estimating a probability of one or more of the plurality of latent tensor elements; and the entropy encoder comprising means for outputting a bitstream encoded at least partly based on the plurality of latent tensor elements and the probability of one or more of the plurality of latent tensor elements.

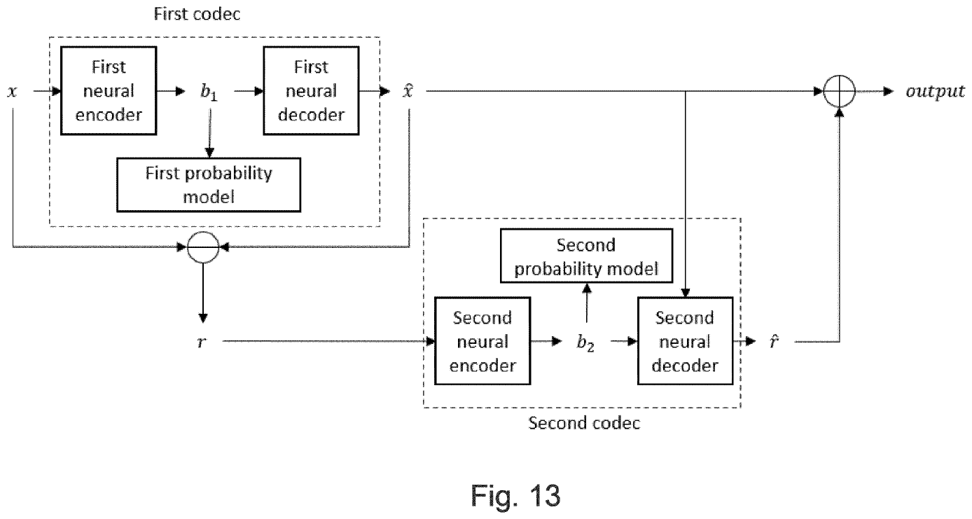

In the following, some embodiments are illustrated by referring to FIGS. 13-16. An embodiment referring to FIG. 17 was described above. It is noted that in FIGS. 13, 14, 15, 16, and/or 17, the terms “first neural encoder”, “first neural decoder”, “first probability model”, “second neural encoder”, “second neural decoder”, “second probability model” may be referred to also as “neural encoder of first codec”, “neural decoder of first codec”, “probability model of first codec”, “first sub-encoder”, “first sub-decoder”, “probability model of second codec”, respectively.

According to an embodiment, the apparatus comprises means for providing the initial reconstruction of the input data from the output of the first decoder, or data derived from the initial reconstruction of the input data, to an input of the first sub-decoder of the second decoder. Herein, the first sub-decoder may refer, for example, to the “second neural decoder” shown in FIG. 13.

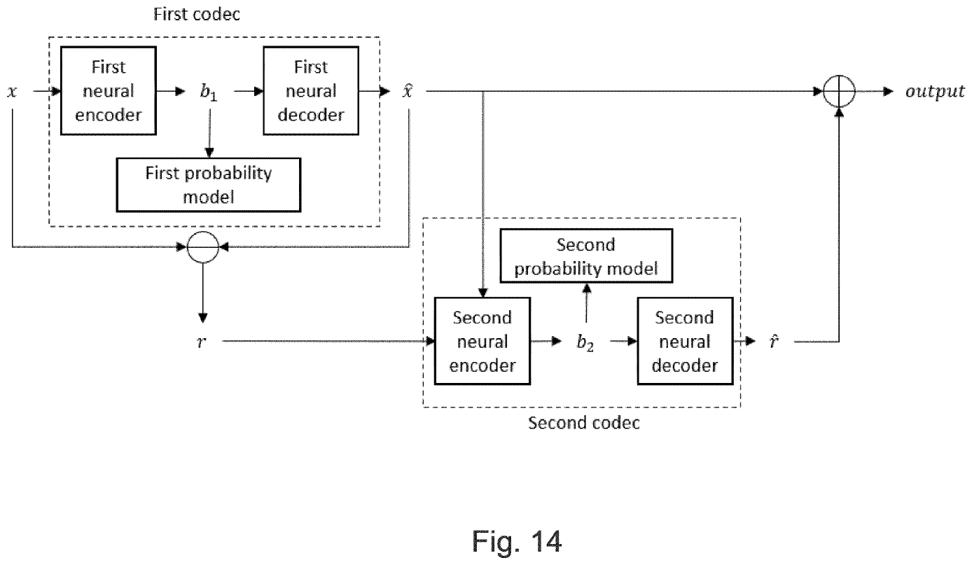

According to an embodiment, the apparatus comprises means for providing the initial reconstruction of the input data from the output of the first decoder, or data derived from the initial reconstruction of the input data, to an input of the first sub-encoder of the second codec. Herein, the first sub-encoder may refer, for example, to the “second neural encoder” shown in FIG. 14.

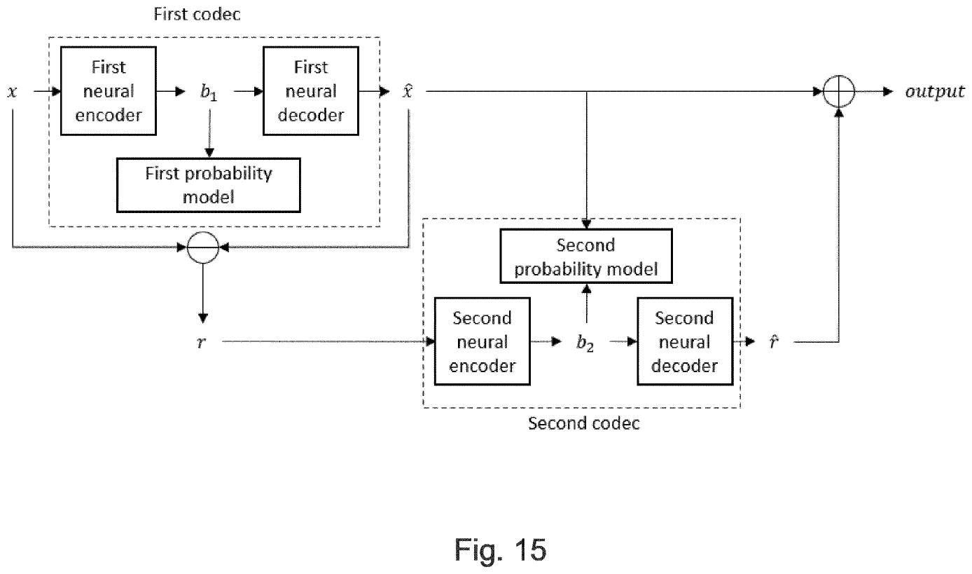

According to an embodiment, the apparatus comprises means for providing the initial reconstruction of the input data from the output of the first decoder, or data derived from the initial reconstruction of the input data, to an input of the probability model used in the encoder of the second codec and to an input of the probability model used in the decoder of the second codec. Herein, the probability models may refer, for example, to the “second probability model” shown in FIG. 15.

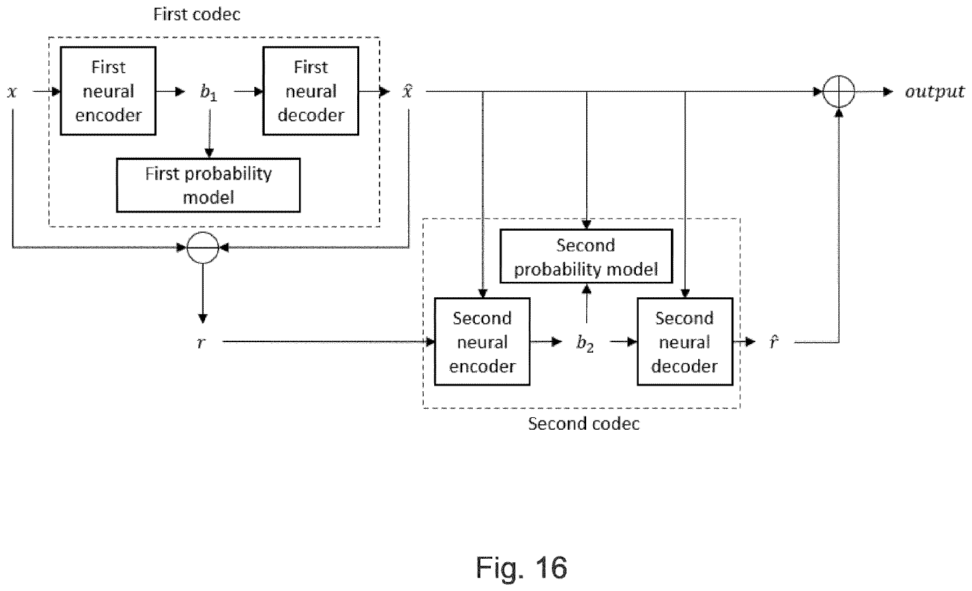

According to an embodiment, the apparatus comprises means for providing the initial reconstruction of the input data from the output of the first decoder, or data derived from the initial reconstruction of the input data, to an input of the first sub-decoder of the second decoder, to an input of the first sub-encoder of the second codec, and to an input of the probability model used in the encoder of the second codec and to an input of the probability model used in the decoder of the second codec. This embodiment is illustrated in FIG. 16.

An apparatus according to another aspect comprises means for receiving input data comprising an initial reconstruction of an input data of an encoder, an encoded residual, wherein the encoded residual is determined based at least on a ground truth data of the encoder and the initial reconstruction of the input data and an adaptation signal into a decoder, said decoder comprising at least a first sub-decoder, a syntax generation unit and a probability model; means for obtaining an entropy decoded residual based at least on the encoded residual and on one or more probabilities of the probability model, wherein the entropy decoded residual is represented as a plurality of decoded latent tensor elements; means for providing the entropy decoded residual to the first sub-decoder; means for providing the adaptation signal to the syntax generation unit for generating one or more syntaxes based on the adaptation signal; means for adapting decoding of the residual in the first sub-decoder based on said one or more syntaxes; means for obtaining a reconstructed residual from an output of the first sub-decoder; and means for combining the reconstructed residual with initial reconstruction of the input data to obtain a final reconstruction of the input data.

According to an embodiment, said decoder comprises an entropy decoder and a neural decoder; wherein the probability model of the decoder comprising means for estimating a probability of one or more elements in the plurality of decoded latent tensor element; the entropy decoder comprising means for outputting a plurality of decoded latent tensor elements at least partly based on the input data and the probability of one or more elements in the plurality of latent tensor element; and the neural decoder comprising means for converting the plurality of decoded latent tensor elements into the reconstructed chroma component.

According to an embodiment, said first sub-decoder of the decoder is a neural decoder comprising one or more spatial attention units for receiving said one or more syntaxes and adapting the decoding of the residual component.

According to an embodiment, the adaptation signal input to the syntax generation network is a dequantized latent tensor output by another codec.

According to an embodiment, the adaptation signal input to the syntax generation network is the initial reconstruction of input data.

According to an embodiment, the adaptation signal input to the syntax generation network is an output of an auxiliary encoder.

According to an embodiment, the decoder belongs to an end-to-end learned intra-frame codec.

According to an embodiment, said means for combining is configured to omit the initial reconstruction of the input data upon obtaining the final reconstruction of the input data.

As a further aspect, there is provided an apparatus comprising: at least one processor and at least one memory, said at least one memory stored with code thereon, which when executed by said at least one processor, causes the apparatus to perform at least: receive input data comprising a first ground truth data; provide the first ground truth data into a first encoder, said ground truth data comprising at least a first part of the input data; obtain an initial encoded input data from an output of the first encoder; provide the initial encoded input data into a first decoder; obtain an initial reconstruction of the input data from an output of the first decoder; determine a residual based at least on the first ground truth data and the initial reconstruction of the input data; provide a second ground truth data comprising at least the residual into a second encoder, said second encoder comprising at least a first sub-encoder for the second ground truth data and a probability model; provide the second ground truth data into the first sub-encoder; provide an output of the first sub-encoder to the probability model; obtain one or more first probabilities from an output of the probability model; and obtain, based on the output of the first sub-encoder and on the one or more probabilities, an encoded residual information from an output of the second encoder.

According to an embodiment, the first encoder, the first decoder and the second encoder belong to an end-to-end learned intra-frame codec.

According to an embodiment, said first encoder comprises a neural encoder, a probability model and an entropy encoder; the neural encoder comprising code configured to cause the apparatus to convert the input data into a plurality of latent tensor elements; the probability model comprising code configured to cause the apparatus to estimate a probability of one or more of the plurality of latent tensor elements; and the entropy encoder comprising code configured to cause the apparatus to output a bitstream encoded at least partly based on the plurality of latent tensor elements and the probability of one or more of the plurality of latent tensor elements.

According to an embodiment, the apparatus comprises code configured to provide the initial reconstruction of the input data from the output of the first decoder, or data derived from the initial reconstruction of the input data, to an input of a first sub-decoder of a second decoder.

According to an embodiment, the apparatus comprises code configured to provide the initial reconstruction of the input data from the output of the first decoder, or data derived from the initial reconstruction of the input data, to an input of the first sub-encoder of the second encoder.

According to an embodiment, the apparatus comprises code configured to provide the initial reconstruction of the input data from the output of the first decoder, or data derived from the initial reconstruction of the input data, to an input of the probability model used in the second encoder and to an input of the probability model used in the second decoder.

As a yet further aspect, there is provided an apparatus comprising: at least one processor and at least one memory, said at least one memory stored with code thereon, which when executed by said at least one processor, causes the apparatus to perform at least: receiving input data comprising an initial reconstruction of an input data of an encoder, an encoded residual, wherein the encoded residual is determined based at least on a ground truth data of the encoder and the initial reconstruction of the input data and an adaptation signal into a decoder, said decoder comprising at least a first sub-decoder, a syntax generation unit and a probability model; obtain an entropy decoded residual based at least on the encoded residual and on one or more probabilities of the probability model, wherein the entropy decoded residual is represented as a plurality of decoded latent tensor elements; provide the entropy decoded residual to the first sub-decoder; provide the adaptation signal to the syntax generation unit for generating one or more syntaxes based on the adaptation signal; adapt decoding of the residual in the first sub-decoder based on said one or more syntaxes; obtain a reconstructed residual from an output of the first sub-decoder; and combine the reconstructed residual with initial reconstruction of the input data to obtain a final reconstruction of the input data.

According to an embodiment, said decoder comprises an entropy decoder and a neural decoder; wherein the probability model of the decoder comprises code configured to cause the apparatus to estimate a probability of one or more elements in the plurality of decoded latent tensor element; the entropy decoder comprising code configured to cause the apparatus to output a plurality of decoded latent tensor elements at least partly based on the input data and the probability of one or more elements in the plurality of latent tensor element; and the neural decoder comprising code configured to cause the apparatus to convert the plurality of decoded latent tensor elements into the reconstructed chroma component.

According to an embodiment, said first sub-decoder of the decoder is a neural decoder comprising one or more spatial attention units for receiving said one or more syntaxes and adapting the decoding of the residual component.

According to an embodiment, the adaptation signal input to the syntax generation network is a dequantized latent tensor output by another codec.

According to an embodiment, the adaptation signal input to the syntax generation network is the initial reconstruction of input data.

According to an embodiment, the adaptation signal input to the syntax generation network is an output of an auxiliary encoder.

According to an embodiment, the decoder belongs to an end-to-end learned intra-frame codec.

According to an embodiment, the apparatus comprises code configured to omit the initial reconstruction of the input data upon obtaining the final reconstruction of the input data.

Such apparatuses may comprise e.g. the functional units disclosed in any of the FIGS. 1-7 and 10-12 for implementing the embodiments.

Such an apparatus further comprises code, stored in said at least one non-transitory memory, which when executed by said at least one processor, causes the apparatus to perform one or more of the embodiments disclosed herein.

In the above, where the example embodiments have been described with reference to an encoder, it needs to be understood that the resulting bitstream and the decoder may have corresponding elements in them. Likewise, where the example embodiments have been described with reference to a decoder, it needs to be understood that the encoder may have structure and/or computer program for generating the bitstream to be decoded by the decoder. For example, some embodiments have been described related to generating a prediction block as part of encoding. Embodiments can be similarly realized by generating a prediction block as part of decoding, with a difference that coding parameters, such as the horizontal offset and the vertical offset, are decoded from the bitstream than determined by the encoder.

The embodiments of the invention described above describe the codec in terms of separate encoder and decoder apparatus in order to assist the understanding of the processes involved. However, it would be appreciated that the apparatus, structures and operations may be implemented as a single encoder-decoder apparatus/structure/operation. Furthermore, it is possible that the encoder and decoder may share some or all common elements.

Although the above examples describe embodiments of the invention operating within a codec within an electronic device, it would be appreciated that the invention as defined in the claims may be implemented as part of any video codec. Thus, for example, embodiments of the invention may be implemented in a video codec which may implement video coding over fixed or wired communication paths.

Thus, user equipment may comprise a video codec such as those described in embodiments of the invention above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1. An apparatus comprising at least one processor; and at least one memory storing instructions that, when executed by the at least one processor, cause the apparatus at least to:
receive input data comprising a first ground truth data;
provide the first ground truth data into a first encoder, said ground truth data comprising at least a first part of the input data;
obtain an initial encoded input data from an output of the first encoder;
provide the initial encoded input data into a first decoder;
obtain an initial reconstruction of the input data from an output of the first decoder;
determine a residual based at least on the first ground truth data and the initial reconstruction of the input data;
provide a second ground truth data comprising at least the residual into a second encoder, said second encoder comprising at least a first sub-encoder and a probability model;
provide the second ground truth data into the first sub-encoder;
provide an output of the first sub-encoder to the probability model;
obtain one or more first probabilities from an output of the probability model; and
obtain, based on the output of the first sub-encoder and on the one or more probabilities, an encoded residual information from an output of the second encoder.

2. The apparatus according to claim 1, wherein the first encoder, the first decoder and the second encoder belong to an end-to-end learned intra-frame codec.

3. The apparatus according to claim 1, wherein
said first encoder comprises a neural encoder, a probability model and an entropy encoder;
the neural encoder is configured to convert the input data into a plurality of latent tensor elements;
the probability model is configured to estimate a probability of one or more of the plurality of latent tensor elements; and
the entropy encoder is configured to output a bitstream encoded at least partly based on the plurality of latent tensor elements and the probability of one or more of the plurality of latent tensor elements.

4. The apparatus according to any claim 1, wherein the instructions, when executed by the at least one processor, cause the apparatus at least to:
provide the initial reconstruction of the input data from the output of the first decoder, or data derived from the initial reconstruction of the input data, to an input of a first sub-decoder of a second decoder.

5. The apparatus according to claim 1, wherein the instructions, when executed by the at least one processor, cause the apparatus at least to:
provide the initial reconstruction of the input data from the output of the first decoder, or data derived from the initial reconstruction of the input data, to an input of the first sub-encoder of the second encoder.

6. The apparatus according to claim 1, wherein the instructions, when executed by the at least one processor, cause the apparatus at least to:
provide the initial reconstruction of the input data from the output of the first decoder, or data derived from the initial reconstruction of the input data, to an input of the probability model used in the second encoder and to an input of the probability model used in the second decoder.

7. A method comprising:
receiving input data comprising a first ground truth data;
providing the first ground truth data into a first encoder, said ground truth data comprising at least a first part of the input data;
obtain an initial encoded input data from an output of the first encoder;
providing the initial encoded input data into a first decoder;
obtain an initial reconstruction of the input data from an output of the first decoder;
determining a residual based at least on the first ground truth data and the initial reconstruction of the input data;
providing a second ground truth data comprising at least the residual into a second encoder, said second encoder comprising at least a first sub-encoder and a probability model;
providing the second ground truth data into the first sub-encoder;
providing an output of the first sub-encoder to the probability model;
obtain one or more first probabilities from an output of the probability model; and
obtain, based on the output of the first sub-encoder and on the one or more probabilities, an encoded residual information from an output of the second encoder.

8. An apparatus comprising at least one processor; and at least one memory storing instructions that, when executed by the at least one processor, cause the apparatus at least to:
receive input data comprising an initial reconstruction of an input data of an encoder, an encoded residual, wherein the encoded residual is determined based at least on a ground truth data of the encoder and the initial reconstruction of the input data and an adaptation signal into a decoder, said decoder comprising at least a first sub-decoder, a syntax generation unit and a probability model;
obtain an entropy decoded residual based at least on the encoded residual and on one or more probabilities of the probability model, wherein the entropy decoded residual is represented as a plurality of decoded latent tensor elements;
provide the entropy decoded residual to the first sub-decoder;
provide the adaptation signal to the syntax generation unit for generating one or more syntaxes based on the adaptation signal;
means for adapting decoding of the residual in the first sub-decoder based on said one or more syntaxes;
obtain a reconstructed residual from an output of the first sub-decoder; and
combine the reconstructed residual with initial reconstruction of the input data to obtain a final reconstruction of the input data.

9. The apparatus according to claim 8, wherein
said decoder comprises an entropy decoder and a neural decoder; wherein
the probability model of the decoder is configured to at least estimate a probability of one or more elements in the plurality of decoded latent tensor element;
the entropy decoder is configured to at least output a plurality of decoded latent tensor elements at least partly based on the input data and the probability of one or more elements in the plurality of latent tensor element; and
the neural decoder is configured to at least convert the plurality of decoded latent tensor elements into the reconstructed chroma component.

10. The apparatus according to claim 8, wherein
said first sub-decoder of the decoder is a neural decoder comprising one or more spatial attention units for receiving said one or more syntaxes and adapting the decoding of the residual component.

11. The apparatus according to claim 8, wherein
the adaptation signal input to the syntax generation network is a dequantized latent tensor output by another codec.

12. The apparatus according to claim 8, wherein
the adaptation signal input to the syntax generation network is the initial reconstruction of input data.

13. The apparatus according to claim 8, wherein
the adaptation signal input to the syntax generation network is an output of an auxiliary encoder.

14. The apparatus according to claim 8, wherein the decoder belongs to an end-to-end learned intra-frame codec.

15. The apparatus according to claim 8, wherein said means for combining is configured to omit the initial reconstruction of the input data upon obtain the final reconstruction of the input data.

16. A method comprising receiving input data comprising an initial reconstruction of an input data of an encoder, an encoded residual, wherein the encoded residual is determined based at least on a ground truth data of the encoder and the initial reconstruction of the input data and an adaptation signal into a decoder, said decoder comprising at least a first sub-decoder, a syntax generation unit and a probability model;
obtain an entropy decoded residual based at least on the encoded residual component and on one or more probabilities of the probability model, wherein the entropy decoded residual is represented as a plurality of decoded latent tensor elements;
providing the entropy decoded residual to the first sub-decoder;
providing the adaptation signal to the syntax generation unit for generating one or more syntaxes based on the adaptation signal;
adapting decoding of the residual in the first sub-decoder based on said one or more syntaxes;
obtain a reconstructed residual from an output of the first sub-decoder; and
combining the reconstructed residual with initial reconstruction of the input data to obtain a final reconstruction of the input data.

17. The apparatus according to claim 16, wherein
said decoder comprises an entropy decoder and a neural decoder; wherein
the probability model of the decoder is configured to at least estimate a probability of one or more elements in the plurality of decoded latent tensor element;
the entropy decoder is configured to at least output a plurality of decoded latent tensor elements at least partly based on the input data and the probability of one or more elements in the plurality of latent tensor element; and
the neural decoder is configured to at least convert the plurality of decoded latent tensor elements into the reconstructed chroma component.

18. The apparatus according to claim 16, wherein
said first sub-decoder of the decoder is a neural decoder comprising one or more spatial attention units for receiving said one or more syntaxes and adapting the decoding of the residual component.

19. The apparatus according to claim 16, wherein
the adaptation signal input to the syntax generation network is one of a dequantized latent tensor output by another codec, the initial reconstruction of input data and an output of an auxiliary encoder.

20. The apparatus according to claim 16, wherein the decoder belongs to an end-to-end learned intra-frame codec.
